(19) United States
(12) Patent Application Publication
(10) Pub. No.: US 2017/0160704 A1
(43) Pub. Date: Jun. 8, 2017

(54) MANAGEMENT SYSTEM FOR MANAGING INFORMATION SYSTEM

(71) Applicant: HITACHI, LTD., Tokyo (JP)

(72) Inventors: Taiki EIRAKU, Tokyo (JP); Yuusuke ASAI, Tokyo (JP)

(73) Assignee: HITACHI, LTD., Tokyo (JP)

(21) Appl. No.: 15/327,595

(22) PCT Filed: Feb. 24, 2015
(86) PCT No.: PCT/JP2015/055170

§ 371 Date: Jan. 19, 2017

(51) Int. Cl. G05B 13/02; G06F 17/30; G06Q 10/06; G06F 3/00; G05B 15/00; G05B 19/042

(52) U.S. Cl. CPC G05B 13/02; G05B 15/00; G05B 19/0423; G06Q 10/06; G06F 3/00; G06F 17/30002; G06F 17/30091

(57) ABSTRACT

A management system determines whether or not there exists a display rule which considers a selected type of a type to which one or more elements selected based on a monitoring result belongs, to be a first type. When a result of the determination is positive, the management system displays two or more columns arranged in an arrangement order in accordance with the display rule. The display rule is a customized rule and includes the first type, one or more second types, and an arrangement order of display of two or more columns respectively. A first column, a column corresponding to the selected type, displays one or more objects respectively corresponding to the one or more selected elements. Each of one or more second columns displays an object corresponding to an element belonging to a type corresponding to the second column and is topologically related to at least one of the one or more selected elements.

### TECHNICAL FIELD

The present invention generally relates to management of an information system including a plurality of elements of a plurality of types.

### BACKGROUND ART

In management of an information system, generally, information related to a plurality of elements included in the information system is displayed and, based on the displayed information, a manager manages the information system. A known example of a technique of this type is described in PTL 1. According to PTL 1, elements of an information system are displayed in multiple columns and end-to-end relationships among the elements are drawn in lines.

### CITATION LIST

### Patent Literature

[PTL 1]

WO 2009/122626

### SUMMARY OF INVENTION

### Technical Problem

Due to trends in cloud systems and the like, information systems have increased in size and have evolved to include components of various types. However, performing multi-column display of elements in such an information system with the technique disclosed in PTL 1 results in an increase in the number of columns and, consequently, a decline in visibility.

### Solution to Problem

A management system determines whether or not there exists a display rule which considers a selected type that is a type to which one or more elements selected based on a monitoring result belong, to be a first type. When a result of the determination is positive, the management system displays two or more columns arranged in an arrangement order in accordance with the display rule. The display rule is a customized rule. The display rule includes the first type, one or more second types, and an arrangement order of display of two or more columns respectively corresponding to the first type and the one or more second types. A first column (a lead column) that is a column corresponding to the selected type displays one or more objects respectively corresponding to the one or more selected elements. Each of one or more second columns (one or more columns other than the first column) displays an object that corresponds to an element which belongs to a type corresponding to the second column and which is topologically related to at least one of the one or more selected elements.

### Advantageous Effects of Invention

Visibility does not decline even when the number of elements increases.

### BRIEF DESCRIPTION OF DRAWINGS

FIG. 1 shows configurations of an information system and a management system according to an embodiment.

FIG. 2 shows an example of a topological element configuration.

FIG. 3 shows an example of an overall configuration screen.

FIG. 4 shows an example of a failure investigation screen.

FIG. 5 shows an example of a failure investigation screen.

FIG. 6 shows an example of an overall configuration screen.

FIG. 7 shows an example of a failure investigation screen.

FIG. 8 shows an example of an overall configuration screen.

FIG. 9 shows an example of a failure investigation screen.

FIG. 10 shows an example of a failure investigation screen.

FIG. 11 shows an example of an overall configuration screen.

FIG. 12 shows an example of a failure investigation screen (template applied).

FIG. 13A shows an example of a relationship between user operations and operation contents.

FIG. 13B shows an example of a relationship between user operations and context menus.

FIG. 14 shows an example of an element list table.

FIG. 15 shows an example of an element relation table.

FIG. 16 shows an example of an element metric table.

FIG. 17 shows an example of an element error table.

FIG. 18 shows an example of an error judge table.

FIG. 19 shows an example of a template table.

FIG. 20 shows an example of a flow of a configuration information acquisition process.

FIG. 21 shows an example of a flow of a metric acquisition process.

FIG. 22 shows an example of a flow of an error information acquisition process.

FIG. 23 shows an example of a flow of a column development process.

FIG. 24 shows an example of a flow of a column addition process.

FIG. 25 shows an example of a flow of an influence range display process.

FIG. 26 shows an example of a flow of a temporary template storage process.

FIG. 27 shows an example of a flow of a template storage process.

### DESCRIPTION OF EMBODIMENTS

Hereinafter, an embodiment will be described.

Although information will be described below using expressions such as an “abc table”, information may be expressed by data configurations other than a table. At least one of “abc tables” can be referred to as “abc information” in order to show that information is not dependent on data configuration. In addition, in the following description, a configuration of each table represents an example and one table may be divided into two or more tables, or all of or a part of two or more tables may constitute one table.

In addition, in the following description, a “storage unit” may be one or more storage devices including a memory. For example, among a main storage device (typically, a volatile memory) and an auxiliary storage device (typically, a nonvolatile memory), a storage unit may at least be the main storage device.

In addition, while a “program” is sometimes used as a subject when describing a process in the following description, since a program causes a prescribed process to be performed by appropriately using a storage unit (such as a memory) and/or an interface device (such as a communication port) and the like when being executed by a processor (such as a central processing unit (CPU)), a “processor” may be used instead as a subject of a process. A process described using a program as a subject may be considered a process performed by a processor or by an apparatus or a system including a processor. Furthermore, a processor may include a hardware circuit which performs a part of or all of processing. The program may be installed in an apparatus such as a computer from a program source. The program source may be, for example, a program distribution server or a computer-readable storage medium. When the program source is a program distribution server, the program distribution server may include a processor (for example, a CPU) and a storage unit, and the storage unit may further store a distribution program and a program that is a distribution target. Furthermore, by having the processor of the program distribution server execute the distribution program, the processor of the program distribution server may distribute the program that is the distribution target to other computers.

In addition, in the following description, two or more programs may be realized as one program or one program may be realized as two or more programs.

Furthermore, while a name or an ID is used as identification information of each element and display rule in the following description, a name and an ID may be mutually substitutable or other types of identification information may be used in place of, or in addition to, at least one of a name and an ID. Moreover, in the following description, an “element” signifies a component in an information system. Specifically, an “element” is a collective term encompassing every one of a plurality of nodes (apparatuses) constituting the information system and every one of a plurality of components included in each node. Nodes include physical nodes (for example, a network switch) and logical nodes (for example, a virtual machine). In addition, components include physical components (for example, a microprocessor) and logical components (for example, a logical volume (LDEV)).

In addition, a management system may be constituted by one or more computers. Specifically, for example, when a management computer displays information (specifically, when a management computer displays information on its own display device or when a management computer transmits information for display to a remote display computer), the management computer constitutes a management system. In addition, for example, when functions identical or similar to those of a management computer are realized by a plurality of computers, the plurality of computers (when a display computer performs display, including the display computer) constitute a management system. In the present embodiment, a management server 557 is a management computer and a management client 555 is a display computer.

Furthermore, in the following description, an operation performed by a user (for example, a manager) using an input device on a graphical user interface (GUI) screen as a management screen of an information system will be referred to as a “user operation”. Generally, an input device used in a user operation is a pointing device or a touch screen.

First, an outline of the present embodiment will be described.

In recent years, information systems have seen an increase in scale and an increase in complexity due to, for example, at least one of the factors listed below.

There is an increase in scale of processes handled by an information system.

A large number of processes are executed by an information system as in the case of a cloud service.

There are a larger number of types of nodes in an information system.

Internal configurations of nodes have become more complex and the number of types of components (for example, logical components and physical components) constituting a node has increased, further creating a need to manage such nodes and components.

Proliferation of virtualization technology (for example, server virtualization, network virtualization, storage virtualization, and data center virtualization) enables apparatuses to be divided or aggregated.

Progress has been made in deployment and migration techniques.

In this case, an “increase in scale” refers to an increase in the number of management target elements in an information system such as a node constituting the information system and a component of the node. In addition, an “increase in complexity” refers to at least one of: a relationship of M:1, 1:N, or M:N (where M and N are respectively integers equal to or larger than 2) being established between elements due to an increase in the number of types of management target elements; an increase in a value of at least one of M and N; and a relationship between elements being in a constantly changing state.

On the other hand, in a general topology display technique, all display objects of display target elements are displayed and lines are displayed between display objects to represent relationships between the elements. However, when a general topology display technique is applied to an information system having increased in scale and increased in complexity, a user is unable to promptly identify an element in a problematic state in an efficient manner and cannot comprehend states of related elements in order to analyze the problematic element. The reason therefor falls under at least one of the following.

(A) When there is an increase in scale, the number of display objects to be displayed increases excessively and, accordingly, efficiency declines. For example, when display objects of all elements are to be displayed on one screen, a size of a display object of an individual element decreases. On the other hand, maintaining the size of the display object of an individual element prevents the display objects of all elements from fitting into one screen and a user must go through the hassle of comprehending relationships between elements while scrolling the screen.

(B) When there is an increase in the number of element types, a limit arises in distinguishing element types according to at least one of a shape and a color of display objects. In practical terms, when the size of the display objects is too large, the number of display objects that can be displayed on one screen decreases, but when a large number of element types are represented by icons with small sizes, a shape of an icon cannot be distinguished unless the user pays closer attention to the icon and, consequently, efficiency is impaired.

(C) Due to an increase in complexity and an increase in scale, a large number of display objects and a large number of relational lines between the display objects are drawn. As a result, relationships between elements can no longer be comprehended.

(D) Let us assume that, for the sake of argument, a management system is capable of arranging display objects on a screen in consideration of relationships among elements so that there is little overlapping of relational lines as possible in order to make topology display more comprehensible. However, when a relationship between elements changes over time, the function (a function for adjusting an arrangement position of a display object) causes display objects to be arranged on the screen at different positions between before and after the change in the relationship between the elements. As a result, the user is no longer able to efficiently locate a desired display object on the screen.

In consideration of the above, the present embodiment realizes a novel display system.

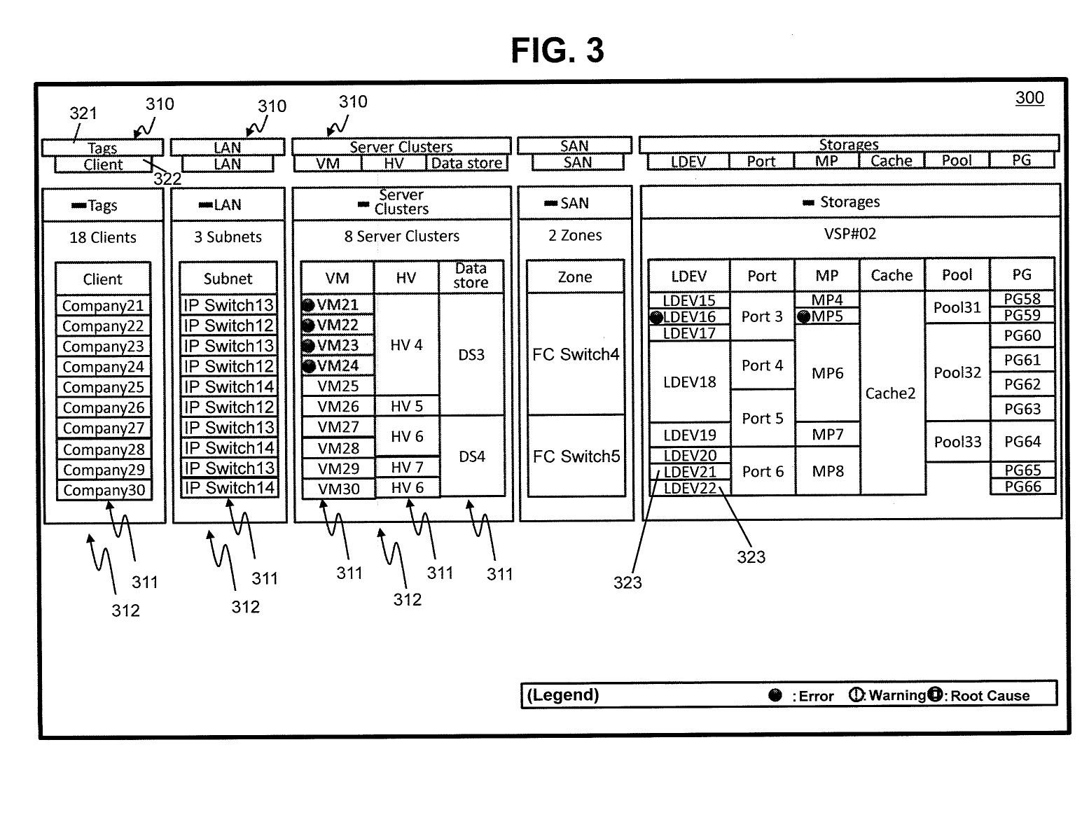

Specifically, for example, a management system determines whether or not there exists a display rule which considers a selected type that is a type to which one or more elements selected based on a monitoring result belongs as a first type. “One or more elements selected based on a monitoring result” maybe, for example, one or more elements (for example, elements of which a metric value exceeds a threshold value) automatically selected based on a monitoring result (for example, respective metric values of a plurality of elements) or one or more elements selected by the user based on a monitoring result (for example, an entire screen illustrated in FIG. 3). An example of a display rule is the “template” as referred to in the present embodiment.

When a result of the determination is positive, the management system displays two or more columns arranged in an arrangement order in accordance with the display rule. While the present embodiment adopts an arrangement order from left to right (an example of an arrangement order along a horizontal direction) as the arrangement order, the arrangement order is not limited thereto and may be an arrangement order with some kind of regularity (for example, right to left, up to down, and down to up).

The display rule is a customized rule or, more specifically, for example, a rule determined in accordance with a previous user operation related to column display as will be described later. The display rule includes a first type, one or more second types, and an arrangement order of display of two or more columns respectively corresponding to the first type and the one or more second types.

A first column (a lead column which corresponds to a selected type) among the two or more displayed columns displays one or more objects respectively corresponding to the one or more selected elements. On the other hand, each of one or more second columns (one or more columns other than the first column) among the two or more displayed columns displays an object that corresponds to an element which belongs to a type corresponding to the second column and which is topologically related to at least one of the one or more selected elements.

In this manner, since columns are displayed in accordance with a customized display rule, typically, columns are displayed after unnecessary columns (and unnecessary elements) have been culled from all columns corresponding to all element types. In other words, column display is narrowed down to necessary columns (and necessary elements). Therefore, visibility can be improved.

Hereinafter, the present embodiment will be described in detail.

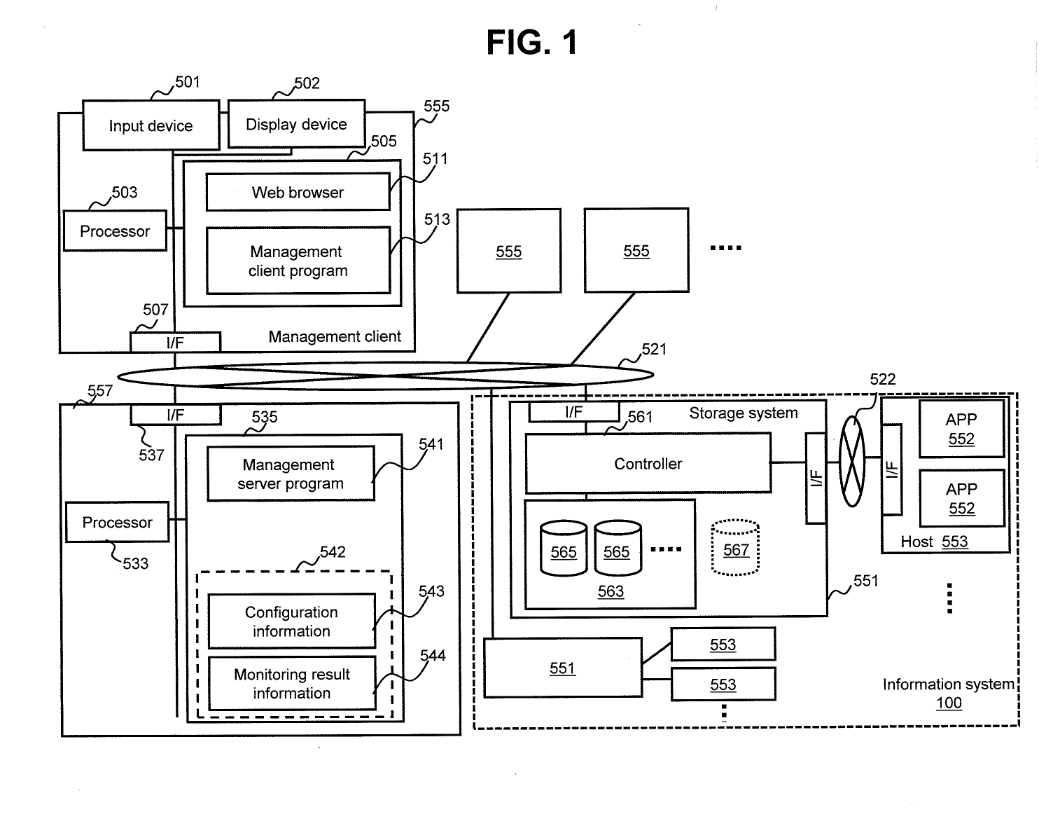

FIG. 1 shows configurations of an information system and a management system according to an embodiment.

An information system 100 may also be referred to as a computer system and includes one or more hosts 553 and one or more storage systems 551 coupled to the one or more hosts 553. The host 553 is coupled to the storage system 551 via, for example, a communication network 521 (for example, a storage area network (SAN) or a local area network (LAN)).

The storage system 551 includes a physical storage device group 563 and a controller 561 coupled to the physical storage device group 563.

The physical storage device group 563 includes one or more parity groups (PGs). A PG may also be referred to as a redundant array of independent (or inexpensive) disks (RAID) group. A PG is constituted by a plurality of physical storage devices and stores data in accordance with a prescribed RAID level. A physical storage device is, for example, a hard disk drive (HDD) or a solid state drive (SSD).

The storage system 551 includes a plurality of logical volumes. Logical volumes include a real logical volume (real volume) 565 based on a PG and a virtual logical volume (virtual volume) 567 in accordance with thin provisioning or storage virtualization technology. One storage system 551 need not necessarily include logical volumes of a plurality of types. For example, the storage system 551 may include only real volumes 565 as logical volumes. A storage area is allocated from a pool to a virtual volume in accordance with thin provisioning. A pool is a group of storage areas based on one or more physical storage devices (for example, PGs) and may be, for example, a set of one or more logical volumes. Instead of a pool having storage areas to be allocated to a virtual volume in accordance with thin provisioning, the pool may be a pool storing a difference between an original logical volume and a snapshot of the original logical volume.

The controller 561 includes a plurality of devices such as a port, an MPB (a blade (circuit board) including one or a plurality of microprocessors (MP)), and a cache memory. For example, the port receives an input/output (I/O) command (a write command or a read command) from the host 553 and an MP included in the MPB controls I/O of data in accordance with the I/O command. Specifically, for example, the MP identifies a logical volume that is an I/O destination from the received I/O command and performs I/O of data with respect to the identified logical volume. Data to be input to or output from a logical volume is temporarily stored in the cache memory.

The host 553 may be a physical computer or a virtual computer. One or more application programs (APP) 552 are executed by the host 553. Due to the APP 552 being executed, an I/O command specifying a logical volume is transmitted from the host 553 to the storage system 551.

As described above, the information system 100 includes a plurality of tiered elements. Specifically, the plurality of elements include two or more types of elements among the APP 552, the host 553, the storage system 551, the controller 561, a port, an MPB, a cache memory, a logical volume, a PG, and the like. A plurality of elements of a same tier may be grouped to define an element of a level above the elements of the same tier. “Elements” may include a real element such as an APP and a logical volume and a virtual element that is a group of a plurality of real elements. In addition, a “parent element” of an element is an element which is associated to the element and of which a tier is one tier higher than that of the element. A “child element” of an element is an element which is associated to the element and of which a tier is one tier lower than that of the element. A child element can also be called a “sub-element”.

The management system includes a management server 557 and one or more management clients 555 coupled to the management server 557. The management client 555 is coupled to the management server 557 via a communication network (for example, a LAN, a world area network (WAN), or the Internet) 521.

The management client 555 includes an input device 501, a display device 502, a storage unit 505, a communication interface device (hereinafter, I/F) 507, and a processor (for example, a central processing unit (CPU)) 503 coupled thereto. The input device 501 is, for example, a pointing device and a keyboard. The display device 502 is, for example, a device including a physical screen on which information is displayed. A touch screen which integrates the input device 501 and the display device 502 may be adopted. The I/F 507 is coupled to the communication network 521, and the management client 555 can communicate with the management server 557 via the I/F 507. Moreover, the communication network 521 and a network which couples the host 553 and the storage system 551 to each other may be partly or entirely common.

The storage unit 505 is capable of storing a computer program to be executed by the processor 503 and information to be used by the processor 503. Specifically, for example, the storage unit 505 stores a web browser 511 and a management client program 513. The management client program 513 may be a rich internet application (RIA). Specifically, for example, the management client program may be a program file to be downloaded from the management server 557 (or another computer) and stored in the storage unit 505.

The management server 557 includes a storage unit 535, an I/F 537, and a processor (for example, a central processing unit (CPU)) 533 coupled thereto. The I/F 537 is coupled to the communication network 521, and the management server 557 can communicate with the management client 555 via the I/F 537. The management server 557 is capable of receiving an instruction in accordance with a user operation and drawing a display object in a layout area via the I/F 537. Therefore, the I/F 537 is an example of an I/O interface device. Moreover, a “layout area” as used herein is an area where a display object may be drawn (which can also be expressed as “arranged”). All of or a part of a range of the layout area is a display range in a frame (for example, a window) which is displayed by the web browser 511 (or the management client program 513). In the layout area in which a display object is drawn, a display image (including the display object) in the frame can be described as a display screen or a GUI screen. Among objects drawn in the layout area, an object overlapping with the display range is displayed on the physical screen of the display device 502. Therefore, substantially, drawing an object in the layout area is an example of displaying an object.

The storage unit 535 is capable of storing a computer program to be executed by the processor 533 and information to be used by the processor 533. Specifically, for example, the storage unit 535 stores a management server program 541 and management information 542. The management information 542 includes configuration information 543 which defines a tiered relationship (configuration information) of a plurality of elements included in the information system and monitoring result information 544 which represents a monitoring result of each element. These pieces of information may be information collected and stored by the management server program 541 or information collected and stored by accessing another management system possessing the information. In this case, the management information 542 may include information defining a tiered relationship or information retaining a monitoring result with respect to the management client 555 that is managed by the management server 557 or components of the management client 555. The management server program 541 receives an instruction in accordance with a user operation from the management client 555 and transmits information to be drawn in the layout area to the management client 555.

A GUI screen display in accordance with a user operation is realized by collaborative processing by the management server program 541, the web browser 511 (or an RIA runtime environment of a client), and the management client program. 513. Examples of collaboration include the following. While a case where the present embodiment adopts (Collaboration example 2) will be described for the sake of simplicity, it is needless to say that the present embodiment is also applicable to (Collaboration example 1).

### Collaboration example 1

The management server program 541 transmits at least a part of information included in the information 543 and the information 544 to the web browser 511 (or the management client program 513), and the web browser 511 (or the management client program 513) stores the information as temporary information in the storage unit 505. The web browser 511 (or the management client program 513) draws a display object (for example, newly draws, enlarges, or reduces a display object) in the layout area based on an instruction in accordance with a user operation and temporary information.

### Collaboration example 2

The management server program 541 receives an instruction in accordance with a user operation with respect to a display screen from the web browser 511 (or the management client program 513), creates information for display of a display object based on the instruction and the information 543 or the information 544, and transmits the information for display. The web browser 511 (or the management client program 513) receives the information for display, and draws a GUI object in the layout area in accordance with the information for display. In simple terms, the management server program 541 draws a display object in the layout area. When a user operation is performed with respect to a GUI screen, the web browser 511 (or the management client program 513) transmits an instruction in accordance with the user operation to the management server program 541.

Hereinafter, in order to avoid redundant descriptions, it will be assumed that display is controlled by the management server program 541.

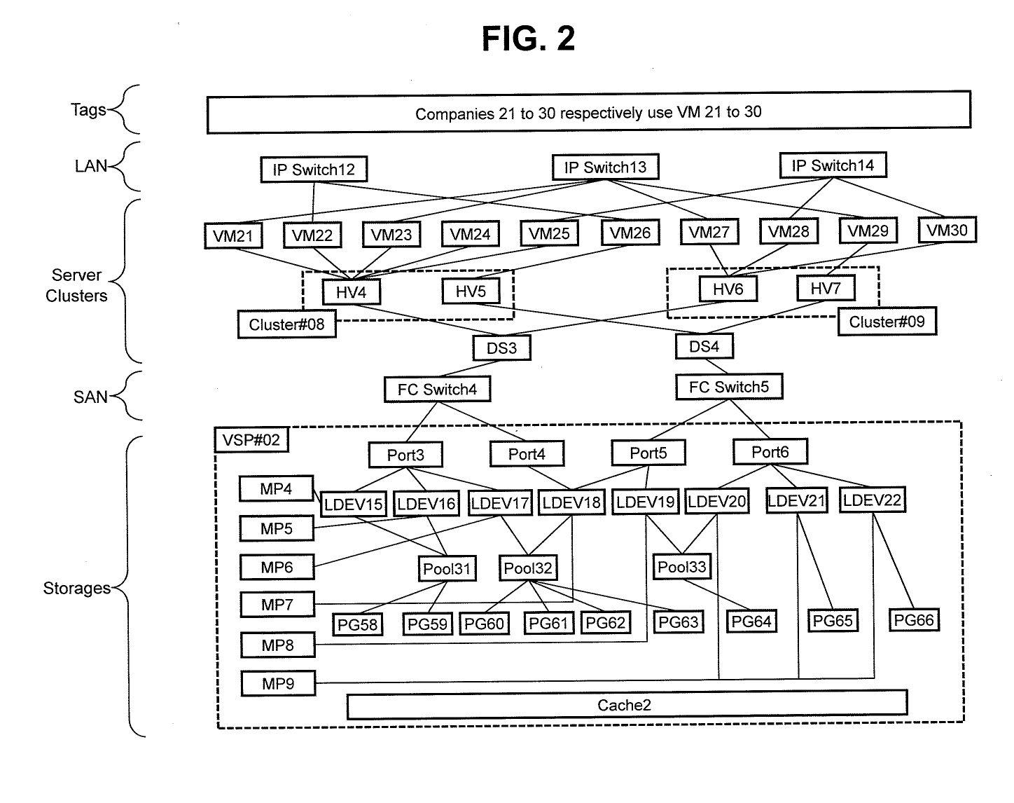

FIG. 2 shows an example of a topological element configuration.

The information system 100 includes one or a plurality of topological element configurations. For example, according to the example shown in FIG. 2, a plurality of layers include, from top to bottom, Tags, LAN, Server Clusters, SAN, and Storages. Each layer represents one element type. Elements belonging to the first layer (highest layer) “Tags” are “Companies” (companies using elements (virtual machines (VMs)) in the information system 100). Elements belonging to the second layer “LAN” are “IP Switches” (IP switches in a LAN). Elements belonging to the third layer “Server Clusters” may be divided into a plurality of types including, specifically, “VM” (a virtual machine executed by a host), “HV” (a hypervisor which controls one or a plurality of virtual machines and which is executed by a host), “Cluster” (a cluster of a hypervisor), and “DS” (a data store). “Cluster” is a parent element of “HV”. “Data store” is an element recognized as a storage device by a hypervisor. Elements belonging to the fourth layer “SAN” are “FC switches” (Fibre Channel (FC) switches in a SAN). Elements belonging to the fifth layer “Storages” are “VSPs” (storage systems). Child elements of “VSP” are components of a plurality of types included in a storage system such as “Port” (a communication port which is coupled to an FC switch and which receives an I/O command from a virtual machine), “LDEV” (a logical volume (a real volume or a virtual volume)), “MP” (a microprocessor), “Pool” (a storage area including a real area to be allocated in accordance with thin provisioning to a virtual volume), “PG” (a parity group), and “Cache” (a cache memory which temporarily stores data to be input to and output from a logical volume).

The example shown in FIG. 2 represents, for example, the following. Companies “Company 21” to “Company 30” use virtual machines “VM 21” to “VM 30” which access a storage system “VSP #02”. The companies “Company 21” to “Company 30” (for example, client computers) access virtual machines “VM 22” and “VM 26” via an IP switch “IP Switch 12”. The virtual machine “VM 22” is controlled by one hypervisor “HV 4” in a cluster “Cluster #08”, and the virtual machine “VM 26” is controlled by another hypervisor “HV 5” in the cluster “Cluster #08”. The virtual machine “VM 22” inputs/outputs data to/from a storage device “DS 3” of the hypervisor “HV 4”, and data input/output to/from the storage device “DS 3” is input/output to/from any of logical volumes “LDEV 15” to “LDEV 18” which are associated with communication ports “Port 3” and “Port 4” via an FC switch “FC Switch 4”. An MP “MP 4” is in charge of the logical volume “LDEV 15”. The logical volume “LDEV 15” is a virtual volume which is associated with a pool “Pool 31” and to which a real area is allocated from the pool “Pool 31”, and the pool “Pool 31” is a storage area based on two parity groups “PG 58” and “PG 59”.

A topological element configuration such as that shown in FIG. 2 is a configuration identified from configuration information represented by the information 543. While display of a GUI image (to be described later) is performed in the present embodiment, the display (for example, displays described with reference to FIGS. 3 to 12) is performed on the management client 555 by the management server 557 (the management server program 541) based on the information 543. Hereinafter, a plurality of examples of a GUI screen displayed on the management client 555 will be described. Moreover, in order to avoid redundancy in the following description, descriptions of the fact that display is performed “by the management server 557 (the management server program 541)” may be omitted. In addition, concepts of “higher level/lower level” and “parent/child” may change depending on what kind of managerial position (for example, a monitoring position) is occupied by the user and may be omitted. For example, when there is a “coupled relationship” between a server and a storage system via an FC switch, which of the server and the storage system is on a higher level or is a parent is not uniquely determined from a simple viewpoint that coupling is established. A determination to consider the server as being on a higher level, to consider the storage system as being on a higher level, or not to introduce the concept of higher/lower levels is to be made in accordance with a standpoint of the user. Conversely, in the case of an inclusion relationship (for example, a node including a component), a concept that the component is on a lower level than the node (or that the component is a child of the node) is often common regardless of the standpoint of the user.

In the present embodiment, when there is a failed element (an element in which a failure is determined to have occurred), the user (for example, a manager) can perform a failure investigation in order to investigate a cause, a response, and the like of the failure. In the present embodiment, a “failure” refers a state that is not normal and, for example, any state of an error and a warning can be collectively referred to as a “failure”. Based on the configuration information 543 and the monitoring result information 544, the management server program 541 can display an overall configuration screen which is a screen representing an overall configuration of a plurality of elements belonging to a plurality of types and which highlights a display object of a failed element. For example, by selecting a failed element from the overall configuration screen, the user can launch an investigation into a failure of the failed element. The management server program 541 determines whether or not there exists a template (a display rule) which considers a selected type that is a type to which the selected element belongs as a first type. Processing to be performed differs depending on a result of this determination.

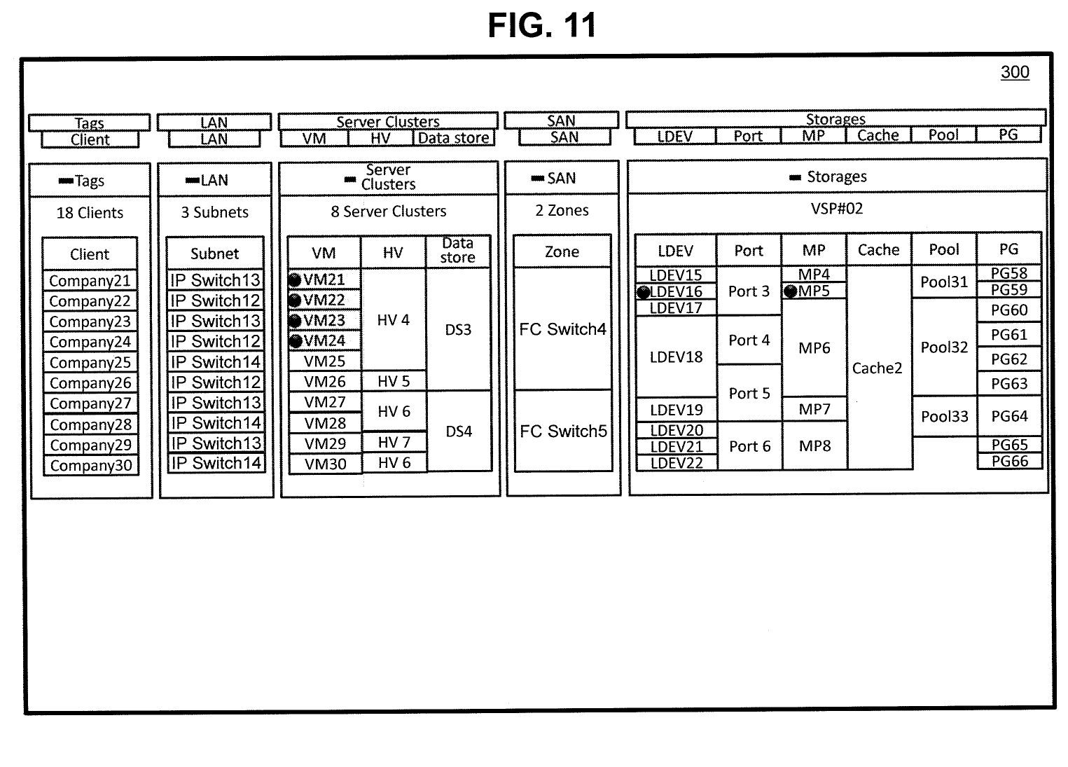

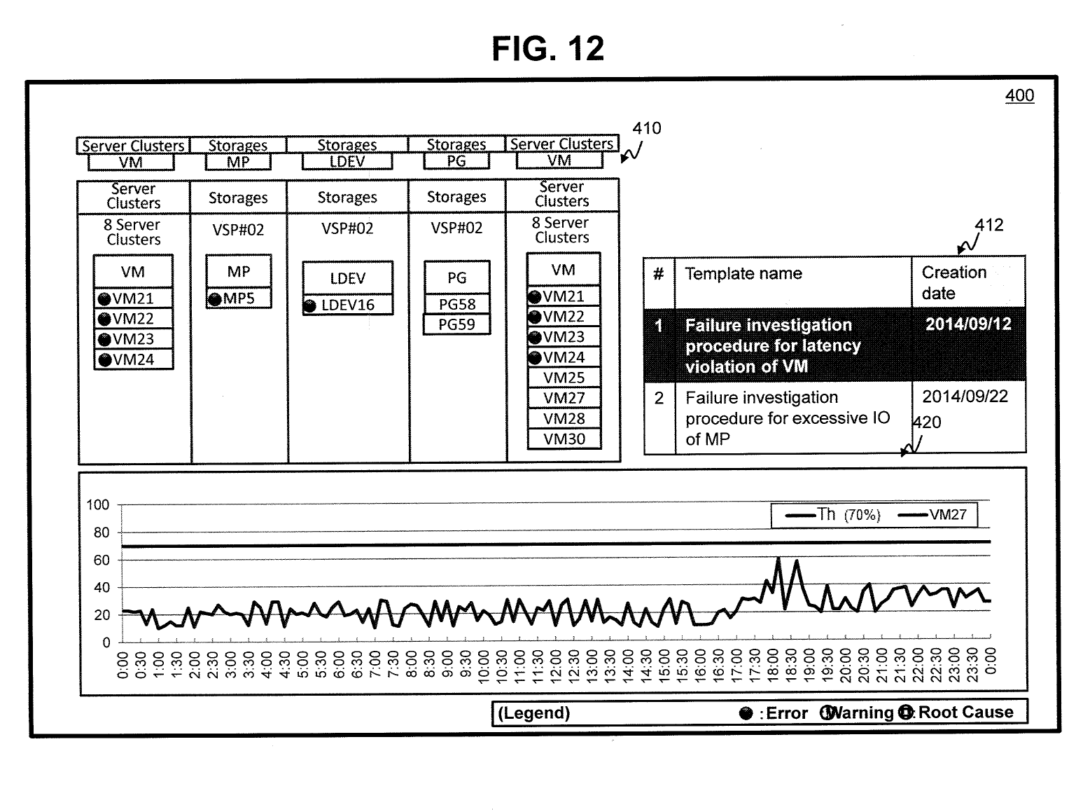

Hereinafter, a failure investigation (without corresponding template) will be described with reference to FIGS. 3 to 10 and a failure investigation (with corresponding template) will be described with reference to FIGS. 11 and 12. Moreover, as the template, when a template storage operation is performed in a failure investigation (without corresponding template), a template determined in accordance with a user operation in the failure investigation (without corresponding template) is stored. Therefore, a failure investigation (without corresponding template) will be described in relative detail.

<Failure Investigation (without Corresponding Template)>

A “failure investigation (without corresponding template)” is a first-time failure investigation or a failure investigation in a case where there is no corresponding template in stored templates.

Let us assume that an overall configuration screen 300 illustrated in FIG. 3 is displayed. The overall configuration screen 300 is a screen showing a configuration of elements of an entire information system. The overall configuration screen 300 is created by the management server program 541 based on the configuration information 543 and the monitoring result information 544.

On the overall configuration screen 300, a plurality of element type objects 310 are displayed arranged in a horizontal direction, and a plurality of element type group columns 312 respectively corresponding to the plurality of element type objects 310 are also displayed arranged in the horizontal direction. The element type group column 312 corresponding to an element type object 310 is displayed directly below the element type object 310. In addition, an element type corresponding to the object 310 more towards a left side of the screen is an element type of a higher level. In other words, element types are arranged in a descending order of levels from left to right. Accordingly, a tiered relationship of element types can be comprehended.

The element type object 310 is a set made up of an element type group sub-object 321 and one or more element type sub-objects 322. The element type group sub-object 321 is a display object indicating an element type group (a group of one or more element types), and the element type sub-object 322 is a display object indicating an element type belonging to the element type group. The one or more element type sub-objects 322 are arranged in the horizontal direction. An element type corresponding to an element type sub-object more towards a left side of the screen is an element type of a higher level.

The element type group column 312 is a display object corresponding to an element type group. The element type group column 312 displays one or more element type columns 311 respectively corresponding to one or more element types belonging to the corresponding element type group. The one or more element type columns 311 are also arranged in the horizontal direction, and each element type column 311 is arranged below the element type sub-object 322 corresponding to an element type corresponding to the column 311. In each element type column 311, one or more display objects (element objects) 323 respectively corresponding to one or more elements belonging to an element type corresponding to the column 311 are arranged in a vertical direction. The element object 323 is a display object which displays, for example, a character string representing an element name. While the element object 323 is included in the element type column 311 in the illustrated example, this is simply an example and an association between the element type column 311 and the element object 323 need only be expressed so that it is obvious that an element corresponding to the element object 323 belongs to an element type corresponding to the element type column 311. For this reason, the element object 323 may be arranged so as to exceed the element type column 311.

An element object (for example, the element object “VM 21”) corresponding to an element in which an event of a prescribed type is determined to have occurred (for example, a failed element) is highlighted. “Highlighting” means displaying in a different display mode to a display mode of an element object corresponding to a normal element (an element in which an event of the prescribed type is determined not to have occurred) and may involve, for example, changing a color or a pattern of an element object, a font of a display name, or the like, associating a symbol indicating a type of an event occurring on an element object with the element object, and the like. In the present embodiment, the event is a failure, and a failure is an error or a warning. A warning may indicate that a metric value of a prescribed metric type with respect to an element exceeds a first threshold value, and an error may indicate that a metric value of the prescribed metric type with respect to the element exceeds a second threshold value (where the second threshold value>the first threshold value). In addition, the management server program 541 may estimate an element that is a root cause of a failure by performing a root cause analysis (RCA) and associate a symbol signifying a root cause to an element object corresponding to the element estimated to be the root cause of the failure. Display objects such as the element object 323 and the element type object 310 need only enable an element name to be displayed therein and, for example, various formats such as an icon, a square graphic, and a circular graphic can be used.

The overall configuration screen 300 illustrated in FIG. 3 reveals that the elements “VM 21” to “VM 24” are respectively error elements (elements in which an error is determined to have occurred). It is assumed that a reason for the error determination is a latency violation (latency exceeding the second threshold value).

When performing a failure investigation, the user performs a column development operation by selecting at least one error element object on the overall configuration screen 300. In this case, let us assume that “VM 21” to “VM 24” have been specified. Moreover, while one or a plurality of element objects can be selected, it is assumed that a plurality of element objects are to be selected from the same element type column 311 and that a plurality of element objects indifferent element type columns are not simultaneously selected.

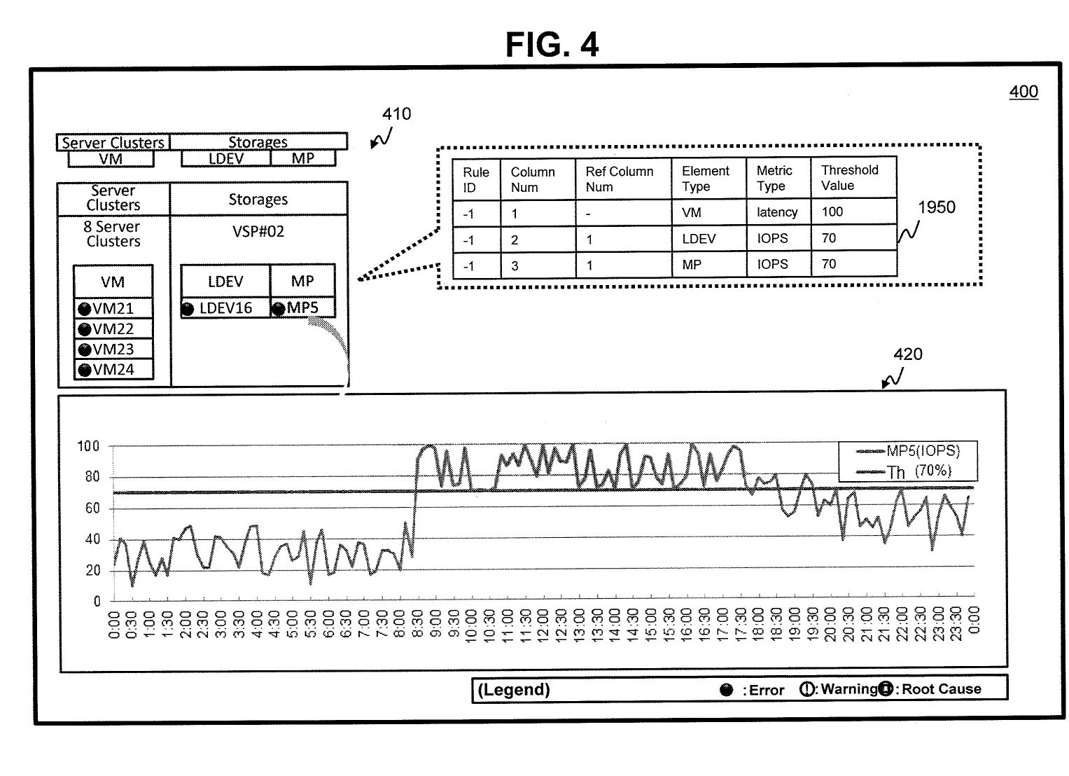

When selection of “VM 21” to “VM 24” and a column development operation are received, the management server program 541 displays a failure investigation screen 400 illustrated in FIG. 4. The failure investigation screen 400 includes a column space 410 and a work space 420. The work space 420 is positioned at any of above, below, left, and right of the column space 410. In the present embodiment, the column space 410 and the work space 420 are both horizontally-long rectangles and the work space 420 is positioned below the column space 410.

In the column space 410, at least one element type object and at least one element type group column are displayed. When a plurality of element type objects and a plurality of element type group columns are displayed, the plurality of element type objects are displayed arranged in the horizontal direction and, in a similar manner, the plurality of element type group columns are also displayed arranged in the horizontal direction. An element type column “VM” including the selected element objects “VM 21” to “VM 24” is displayed by the management server program 541 in the column space 410.

In addition, when the presence of an element satisfying prescribed conditions is detected by the management server program 541 based on the configuration information 543 and the monitoring result information 544, an element type column including an element object corresponding to the element satisfying the prescribed conditions is arranged so as to be aligned on a right side of the element type column “VM”. The prescribed conditions described above are that: (r1) the element satisfying the prescribed conditions is topologically related to at least one element among the selected elements “VM 21” to “VM 24”; (r2) a same event as an event (for example, an error) occurring in the element is occurring in the element satisfying the prescribed conditions; and (r3) the element satisfying the prescribed conditions belongs to an element type that differs from the element type “VM”. An element Y topologically related to an element X is an element which is coupled to the element X either without involving or via a different element (an element other than the elements X and Y). In this case, let us assume that “LDEV 16” and “MP 5” have been detected as elements satisfying the prescribed conditions. As a result, an element type column “LDEV” including the element object “LDEV 16” and an element type column “MP” including the element object “MP 5” are arranged so as to be aligned on the right side of the element type column “VM”. In other words, the fact that the element type column “VM” including the selected elements “VM 21” to “VM 24” is the lead is maintained. Moreover, while a head of a column is a leftmost position in the present embodiment, alternatively, a prescribed position such as center may be considered as the head. Specifically, a “head” may represent a head in terms of physical positions or may represent a head in terms of logical positions (for example, a position assigned a smallest number among orders respectively assigned to a plurality of physical column display positions).

According to the column space 410 illustrated in FIG. 4, as second and subsequent element type columns, only element type columns corresponding to element types to which elements satisfying the prescribed conditions described above belong are displayed. In other words, an element type column corresponding to an element type which does not include even one element satisfying the prescribed conditions described above is not displayed. Therefore, visibility is high. Moreover, the prescribed conditions need not include (r2) (the occurrence of a same event) among (r1) to (r3).

According to the column space 410 illustrated in FIG. 4, in the second and subsequent element type columns, instead of displaying all element objects (elements) belonging to an element type corresponding to the column, element objects are displayed by being narrowed down to elements in which a same event as an event occurring in an element selected by the user (an element corresponding to at least one element object in a lead element type column) is occurring (alternatively, elements may be narrowed down according to another condition related to a relationship with the element selected by the user). Accordingly, a height of an element type column can be suppressed and, by extension, a height of the entire column space 410 can be suppressed. As a result, a height of the work space 420 positioned below (or above) the column space 410 can be secured.

The work space 420 is a space in which details related to an element or an element type specified by the column space 410 are displayed. Examples of details related to a specified element or a specified type may include information indicating a relationship between a time-series variation of a metric value (examples of a metric type include I/O per second (IOPS) and latency) specified as a monitoring result of the specified element and a threshold value of the metric value, information representing a correspondence between an element belonging to the specified type and an element belonging to another type, and an attribute of each element belonging to the specified type. Details related to a specified element or a specified type is information specified by the management server program 541 from at least one of the configuration information 543 and the monitoring result information 544. For example, the user can perform a failure investigation in the information system 100 by referring to both the overall configuration screen 300 and the failure investigation screen 400 (for example, by appropriately switching between the screens or by displaying both screens side by side).

For example, while one of an error of the element “LDEV 16” and an error of the element “MP 5” is conceivably a cause of an error of the elements “VM 21” to “VM 24”, since it is unclear as to which error is the cause, the user performs a detail display operation (user operation) specifying “LDEV 16” or “MP 5”. In response to the detail display operation, the management server program 541 displays details related to the element “LDEV 16” (for example, a relationship between a time-series variation and a threshold value of a metric value corresponding to the metric type “IOPS” (or “response type”)) (not shown) or details related to the element “MP 5” (for example, a relationship between a time-series variation and a threshold value of a metric value corresponding to the metric type “IOPS”) in the work space 420. From the details displayed in the work space 420, the user can learn that an excess over a threshold value is significant in IOPS of the element “MP 5”.

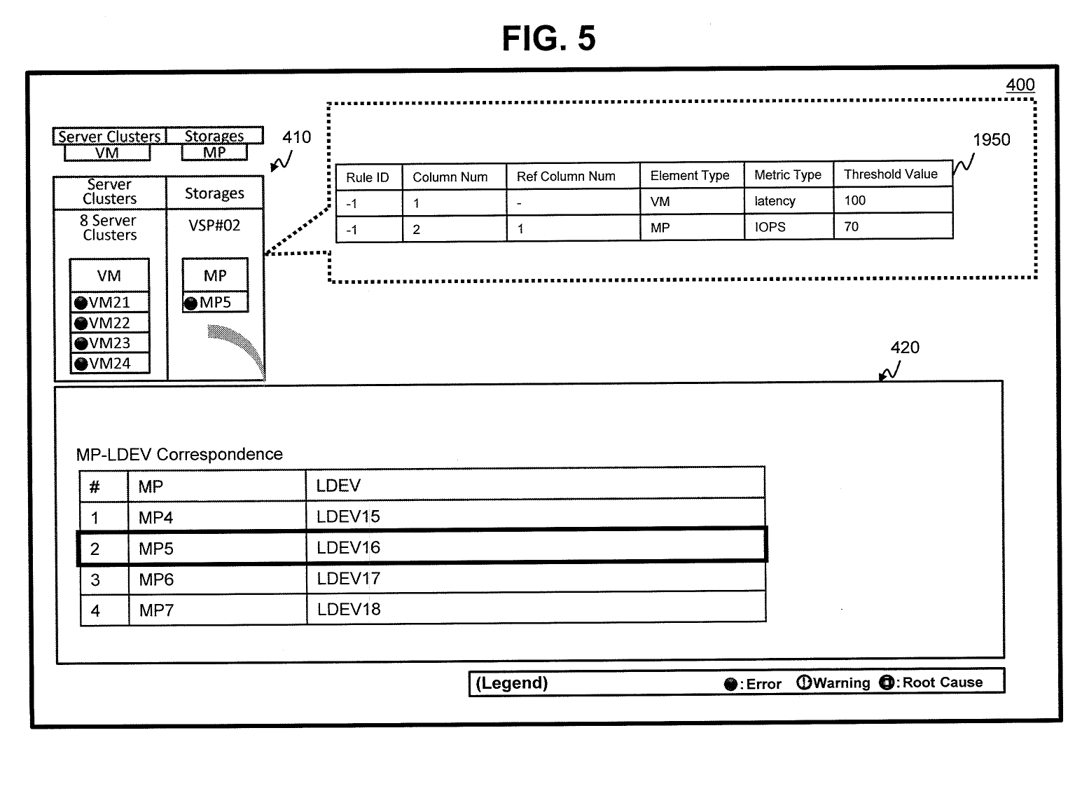

Moreover, every time a display result of the column space 410 is changed in accordance with a user operation (for example, every time at least one of an increase or decrease in the number of element type columns, an increase or decrease in the number of element objects, and a change in an arrangement order of element column types occurs), information related to a display result after the change is registered in a temporary template table 1950. The temporary template table 1950 is a temporary table which is stored in the storage unit 535 and which may be included in the management information 542. A configuration of the temporary template table 1950 is the same as a configuration of a template table (to be described later). In the present embodiment, storing information stored in the temporary template table 1950 in a template table in response to a template storage operation constitutes storing a template. The temporary template table 1950 includes an entry (record) for each element type column displayed in the column space 410. Information to be stored in an entry includes: a “Rule ID” that is identification information of a template; a “Column Num (column number)” that is a number of an element type column corresponding to the entry; a “Ref Column Num (reference destination column number)” that is a number of a reference destination element type column (an immediately previous element type column) ; an “Element Type” that is an element type corresponding to the element type column; a “Metric Type” that is a metric type corresponding to an element (a failed element) in the element type column; and a “Threshold Value” that is a threshold value used when the element had been determined to be a failure. According to FIG. 4, as a rule ID, a value signifying a temporary template (for example, “−1”) is assigned (the rule ID corresponds to an ID of a template). The smaller the column number of a column, the more toward the left the position of the column. In addition, according to FIG. 4, since each of the elements “VM 21” to “VM 24” has been determined to be an error due to the latency of the element exceeding 100, “latency” is registered as the “Metric Type” and “100” is registered as the “Threshold Value”. Moreover, while a display result in the column space 410 and contents of the temporary template table 1950 are shown on the same screen in FIG. 4 in order to make a correspondence therebetween more readily understood, as indicated by a dotted line frame, in reality, the temporary template table 1950 need not be displayed on the screen 400. This explanation similarly applies to FIGS. 5, 7, 9, and 10 to be described later.

Let us now assume that, in order to investigate a cause of the increase in IOPS of “MP 5”, the user has performed a narrowing operation (user operation) to narrow down second and subsequent element type columns only to the element type column “MP” on the failure investigation screen 400 shown in FIG. 4. A result of a display performed in response to the narrowing operation is shown in FIG. 5. According to the failure investigation screen 400 shown in FIG. 5, an entry corresponding to a culled third element type column “LDEV” has been deleted from the temporary template table 1950 by the management server program 541.

Let us assume that the user predicts that a cause of a load on the element “MP 5” is any one of the LDEVs. In this case, the user performs a detail display operation in order to display details including information representing an LDEV of which “MP 5” has ownership. In response to the detail display operation, as shown in FIG. 5, the management server program 541 displays details including information representing an LDEV of which “MP 5” has ownership (for example, a portion at least including information related to “MP 5” in MP-LDEV correspondence information which constitutes a part of the configuration information 543) in the work space 420. From these details, the user learns that “MP 5” has ownership of “LDEV 16”.

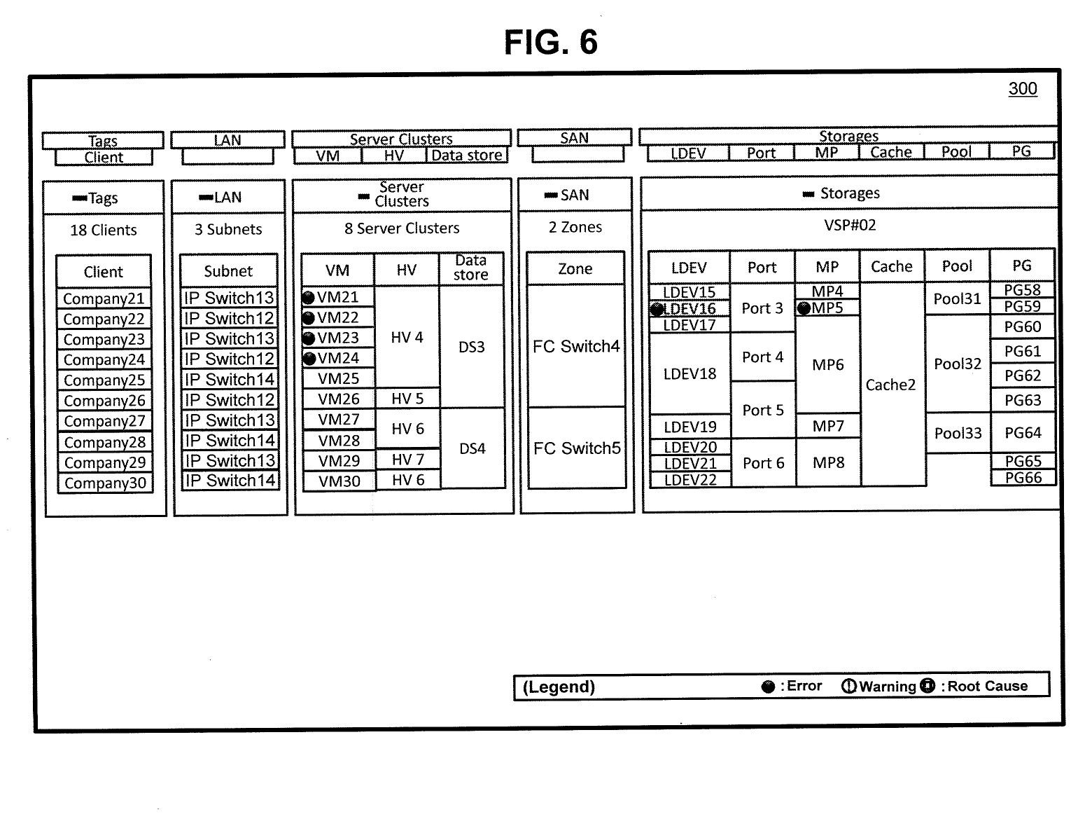

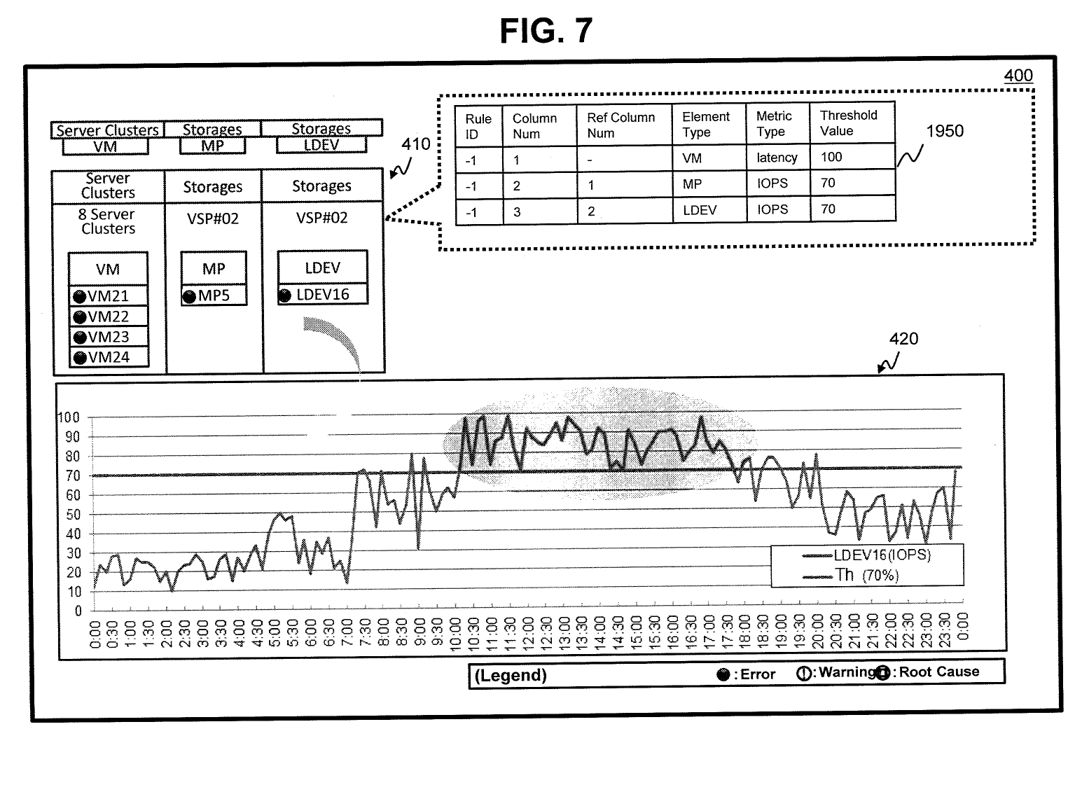

Let us assume that, subsequently, in response to a user operation, the management server program 541 displays the overall configuration screen 300 as shown in FIG. 6. In addition, the management server program 541 receives selection of an element object “LDEV 16” and a column addition operation (user operation). In this case, in response to the column addition operation, as shown in FIG. 7, the management server program 541 displays (adds) the element type column “LDEV” including the selected element object “LDEV 16” to a right side of the rightmost element type column “MP”. In this manner, an element type column including an element object that the user (for example, empirically) determines should be added is displayed (added) at an arbitrary timing of the user to the column space 410. In addition, in accordance with the addition of the element type column, the temporary template table 1950 is updated as shown in FIG. 7.

When the management server program receives an instruction to display details of the element “LDEV 16”, the management server program displays details of the element “LDEV 16” in the work space 420. Examples of the details include information indicating a relationship between a time-series variation and a threshold value of a metric value (IOPS) of “LDEV 16”. From this information, the user can confirm that IOPS of “LDEV 16” has increased from a normal level.

Let us assume that, subsequently, the user performs a user operation for displaying the overall configuration screen in order to identify a PG related to the element “LDEV 16”. Let us also assume that, in response to the user operation, the management server program 541 displays the overall configuration screen 300 as shown in FIG. 8. Let us also assume that, using the screen 300 shown in FIG. 8, the user identifies that PGs related to the element “LDEV 16” are “PG 58” and “PG 59”. The management server program 541 may display an association of elements (elements belonging to other types) which are related to “LDEV 16”. The display of the association may involve, for example, changing heights of respective element objects so that at least parts of a height range of the element object “LDEV 16” and a height range of the element object related to “LDEV 16” overlap with each other or displaying a connection between the specified element object “LDEV 16” and the element object related to “LDEV 16”.

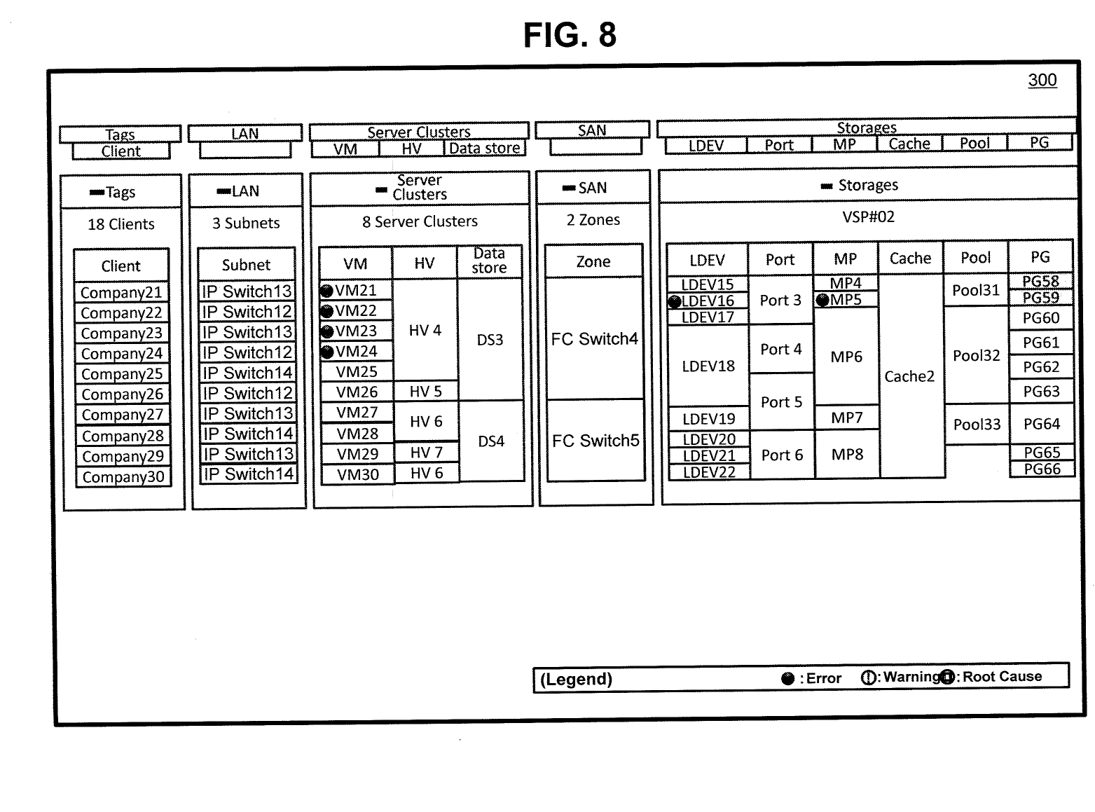

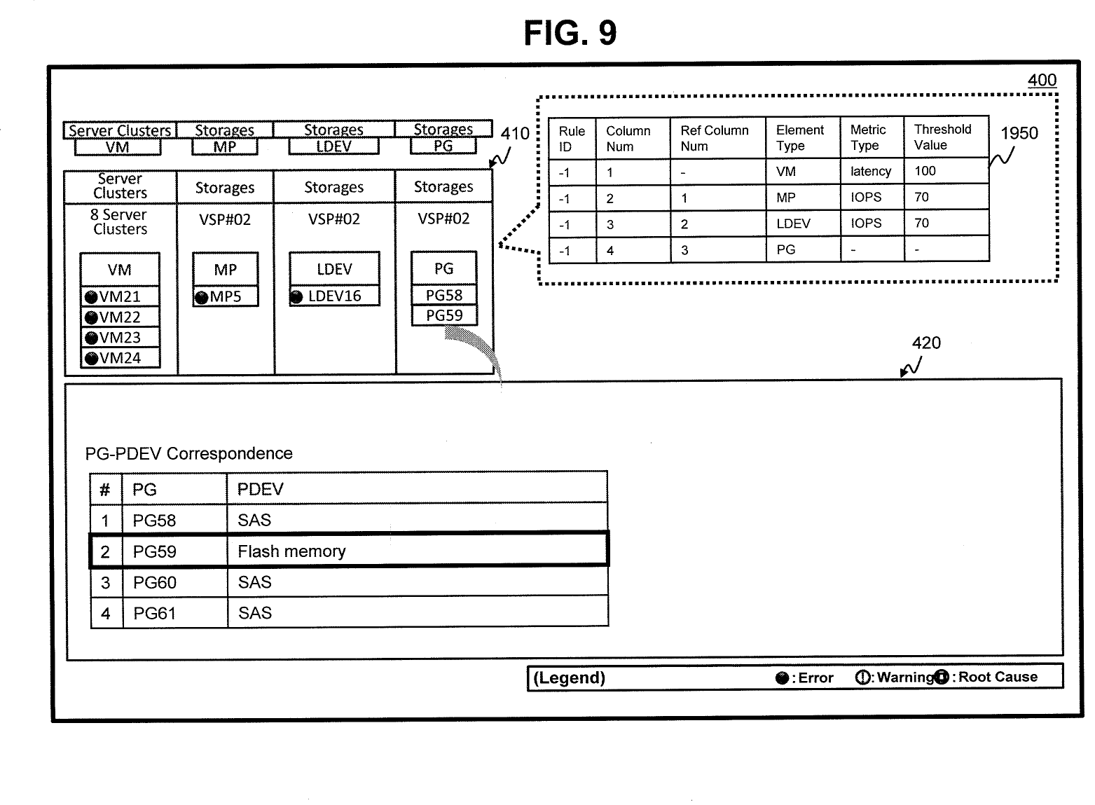

Let us assume that the management server program 541 receives selection of the element objects “PG 58” and “PG 59” and a column addition operation (user operation). In this case, in response to the operation, as shown in FIG. 9, the management server program 541 displays (adds) the element type column “PG” including the selected element objects “PG 58” and “PG 59” to a right side of the rightmost element type column “LDEV”. In accordance with the addition of the element type column “PG”, the temporary template table 1950 is updated as shown in FIG. 9. According to the temporary template table 1950 shown in FIG. 9, since an entry corresponding to the added element type column “PG” has been added but no failure has occurred in the elements “PG 58” and “PG 59”, “Null (−)” is registered as the “Metric Type” and the “Threshold Value”.

By observing the failure investigation screen 400 shown in FIG. 9, the user predicts (for example, empirically) that the cause of the increase in IOPS of “LDEV 16” is the fact that at least one of the elements “PG 58” and “PG 59” is a set of flash memory devices (for example, solid state drives (SSDs)). In this case, the user performs a detail display operation in order to display details related to “PG 58” and “PG 59”. In response to the detail display operation, as shown in FIG. 9, the management server program. 541 displays details related to “PG 58” and “PG 59” (for example, a portion at least including information related to “PG 58” and “PG 59” in PG-PDEV correspondence information which constitutes a part of the configuration information 543) in the workspace 420. From the details, the user confirms that “PG 59” is a set of flash memory devices as predicted or, in other words, the cause of the increase in IOPS of “LDEV 16” is “PG 59”.

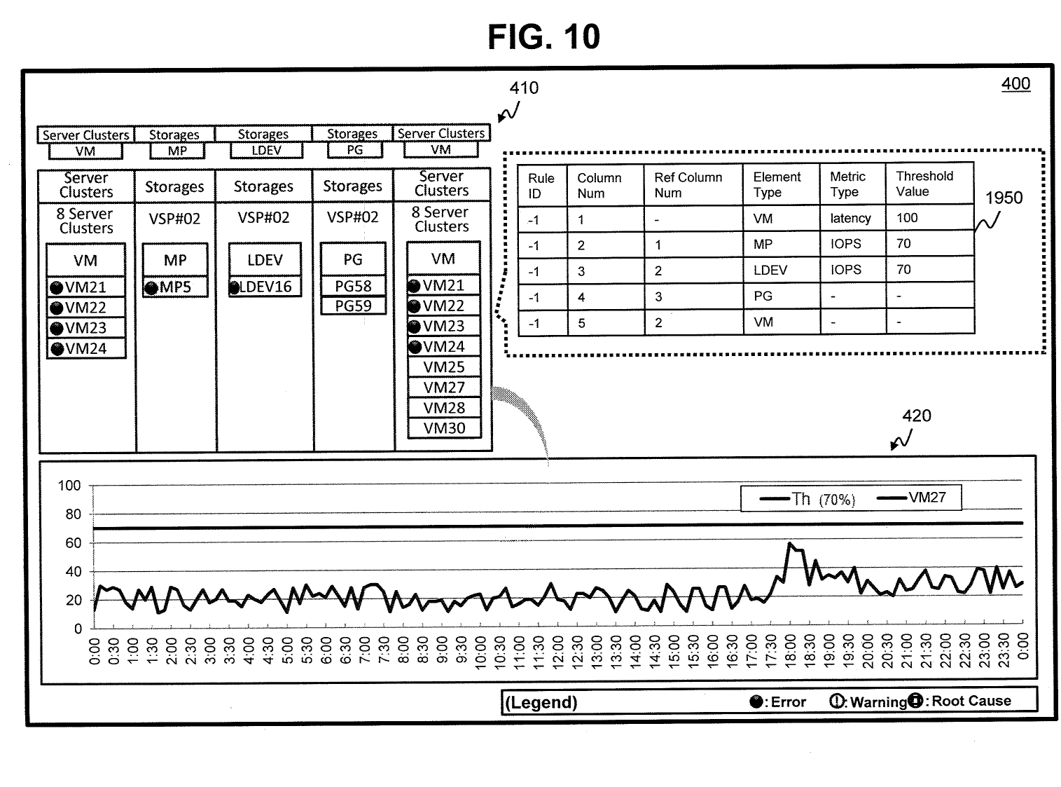

In addition, the management server program 541 is capable of receiving an influence range display operation for displaying an influence range of an element specified by the user. For example, let us assume that the user has found that “PG 58”, “PG 59”, and “LDEV 16” are causes of an increase in load of “MP 5” and performs an influence range display operation specifying “MP 5” in order to identify an influence range of the increase in load of “MP 5”. When receiving an influence range display operation specifying “MP 5”, the management server program 541 updates the failure investigation screen 400 as shown in FIG. 10. Specifically, the management server program 541 adds an element type column to the right of the rightmost element type column “PG”. The added element type column displays an element (element object) which is topologically related to the specified element “MP 5” and which belongs to an element type corresponding to the added column. The element (element object) displayed in the added element type column in response to the influence range display operation need only be c and a same event as an event occurring in the specified element “MP 5” need not be occurring. An element corresponding to an object displayed in the added element type column is conceivably an element to be affected by the specified element “MP 5”. One or a plurality of element types may correspond to the added element type column. Alternatively, an element type corresponding to the added element type column may be specified by the user or determined in advance. In the present embodiment, an element type corresponding to the element type column added in response to the influence range display operation is the same as an element type corresponding to the lead element type column (a column corresponding to a type to which an element initially selected by the user belongs). According to FIG. 10, in addition to the failed elements “VM 21” to “VM 24” initially selected by the user, element objects of the elements “VM 25”, “VM 27”, “VM 28”, and “VM 30” which are topologically related to the specified element “MP 5” are displayed in the added element type column “VM”. Moreover, in accordance with the addition of the element type column “VM”, the temporary template table 1950 is updated as shown in FIG. 10. Since the addition of the element type column “VM” is an addition for the purpose of identifying an influence range, “Null” is respectively registered as the “Metric Type” and the “Threshold Value”.

As described above, in place of or in addition to an element type column only including an element in which a same event as an event occurring in a selected element is occurring, an element type column including an element (in which the same event may or may not be occurring) which is topologically related to the selected element can also be added to the column space 410. Accordingly, the user can comprehend elements conceivably affected by the selected element. In addition, in the present embodiment, while an element type corresponding to a column added in response to an influence range display operation is the same as an element type corresponding to the lead element type column, element objects displayed in the respective columns differ. Therefore, while only the element object initially selected by the user is displayed in the lead element type column “VM”, all element objects of “VM 21” to “VM 24”, “VM 25”, “VM 27”, “VM 28”, and “VM 30” that may be affected by “MP 5” in which an error has occurred are displayed in the added element type column “VM”. Due to this display, elements which are of a same type as an element of interest and which may possibly be affected by an error can be comprehended.

In addition, the user can perform a detail display operation specifying any of the element objects (for example, “VM 27” in the added element type column “VM”. In response to the detail display operation, the management server program 541 displays details (for example, a time-series variation of IOPS) related to the specified element “VM 27” in the work space 420. As a result, a presence or an absence of an effect on an element in an influence range can be confirmed. In this manner, the user can check details on each of “VM 21” to “VM 24”, “VM 25”, “VM 27”, “VM 28”, and “VM 30” that may be affected by “MP 5” in which an error has occurred.

The management server program 541 can receive a template storage operation (user operation) for storing a template (display rule) in accordance with an arbitrary display result of the user. For example, when a template storage operation with respect to a display result (a display result including five element type columns) in the column space 410 shown in FIG. 10 is received, the management server program 541 stores information (all entries) included in the temporary template table 1950 shown in FIG. 10 in a template table (to be described later). Subsequently, the management server program 541 may delete the temporary template table 1950.

This concludes the description of the failure investigation (without corresponding template). Moreover, an element selection and a column addition operation may be received via the failure investigation screen instead of on the overall configuration screen. In other words, an element type column may be addable to a column space in the failure investigation screen without having to display the overall configuration screen.

<Failure Investigation (with Corresponding Template)>

In the description of a “failure investigation (with corresponding template)”, it is assumed that a template indicated by the temporary template table 1950 shown in FIG. 10 (hereinafter, a newly-stored template) exists as the corresponding template and that the configuration information 543 and the monitoring result information 544 are the same as the configuration information 543 and the monitoring result information 544 in the “failure investigation (without corresponding template)” described above.

Let us assume that, as shown in FIG. 11, the same overall configuration screen 300 as shown in FIG. 3 is displayed and the management server program 541 receives selection of “VM 21” to “VM 24” and a column development operation. Attributes (the element type “VM”, the metric type “latency”, and the threshold value “100”) of selected “VM 21” to “VM 24” satisfy conditions (the element type, the metric type, and the threshold value corresponding to the lead element type column) described in a head entry of a newly-created template. Therefore, as shown in FIG. 12, a display result of the column space 410 in the failure investigation screen 400 is exactly the same as the display result shown in FIG. 10. This is because display is performed according to the newly-stored template and the configuration information 543 and the monitoring result information 544 are the same as the configuration information 543 and the monitoring result information 544 in the “failure investigation (without corresponding template)” described above.

In addition, when there is a corresponding template other than the newly-stored template (or when there is even one corresponding template), the management server program 541 may display a corresponding template list 412 on, for example, the failure investigation screen 400. The corresponding template list 412 may include one or more entries respectively corresponding to one or more corresponding templates, and each entry may include a template name (an example of identification information) and a creation date of the corresponding template. Furthermore, the management server program 541 may highlight an entry (for example, a color of the entry or a display mode of a text or the like of the template name or the like may be changed) corresponding to a corresponding template being applied among the one or more corresponding templates shown on the list 412. Accordingly, the user is able to comprehend the number of corresponding templates with respect to selected “VM 21” to “VM 24” and a template being applied.

Moreover, the management server program 541 may receive a selection of a template desired by the user from the corresponding template list 412. When a template other than the applied template is selected, the management server program 541 cancels display of second and subsequent columns (columns other than the lead column) in the column space 410 and displays second and subsequent columns in accordance with the selected template in the column space 410. There may be more than one method of carrying out an investigation (analysis) such as identification of a cause of a failure with respect to selected “VM 21” to “VM 24”. There may be cases where which of the templates yields a display result (a lead column and one or more element type columns on a right side thereof) on which a failure investigation is preferably based can only be determined after actually trying out the templates. In the event where a desired result cannot be obtained even after trying out a selected template, a burden placed on the user is large when the user is required to perform the operations described in “failure investigation (without corresponding template)”. Therefore, being able to switch (select) corresponding templates to be applied by, for example, updating a display result of an application of a certain template to a display result in accordance with a different selected template as in the present embodiment is highly convenient to the user.

Meanwhile, if the configuration information 543 and the monitoring result information 544 differ from the configuration information 543 and the monitoring result information 544 in the “failure investigation (without corresponding template)” described above, a display result may differ even if the attributes of selected “VM 21” to “VM 24” satisfy conditions described in a head entry of a newly-created template. This is because a template does not define a display target element itself but defines conditions related to attributes of the display target element. Therefore, for example, there may be cases where an object that differs from the element object shown in FIG. 10 is displayed or not displayed in any element type box or not one element object is displayed in any element type box (for example, when elements are all normal elements and there is no element satisfying the metric type and the threshold value).

In addition, the management server program 541 is capable of receiving various user operations with respect to a display result (the failure investigation screen shown in FIG. 12) to which a template has been applied. For example, when receiving a detail display operation specifying “VM 27”, the management server program 541 can display details related to “VM 27” (details identified from at least one of the configuration information 543 and the monitoring result information 544) in the work space 420 in a similar manner to the description with reference to FIG. 10 (refer to FIG. 12). Furthermore, when receiving a column addition operation, the management server program 541 can add a column to a right side of the rightmost column “VM”. In addition, when receiving a column narrowing operation, the management server program 541 can delete a specified column (when a middle column is deleted, the management server program 541 can justify the columns to the left).

Furthermore, when any of the corresponding templates is applied, the management server program 541 may copy information of the applied template to the temporary template table 1950. In addition, every time a display result in the column space 410 is changed in response to a user operation, the management server program 541 may update the temporary template table 1950. Furthermore, when receiving a template storage operation, the management server program 541 may overwrite the information in the temporary template table 1950 on the template that is a copy source (in other words, update the applied template itself) or may register the template as a new template in the template table.

According to the description with reference to FIGS. 3 to 12, for example, the following advantageous effects can be stated.

Specifically, with a general topology view, since a relationship between elements are expressed by a connection, an increase in the number of elements results in connections becoming complicatedly entangled and making it difficult to discern elements related to an element of interest (a single selected element) at a glance. It is also difficult to discern elements related to an element of interest (for example, a failed element). Furthermore, since a relationship between elements are expressed by lines, a drawing space for expressing the lines is required, thereby reducing a space for a display target other than the lines. When the number of elements increases, the lines become complicatedly entangled and further drawing space for expressing the lines is required. On the other hand, with the failure investigation screen according to the present embodiment, element type columns are arranged and, at the same time, element type columns that are display targets are reduced. Therefore, visibility is improved. In addition, according to the present embodiment, the element type columns are arranged in the horizontal direction. In other words, an association of an element is expressed by a positional relationship in the horizontal direction. Therefore, in order to discern an element related to an element of interest, the user can discern an element related to the element of interest (and, further, discern an element in which a same event as an event occurring in the element of interest is occurring) by simply shifting his or her line of sight directly sideways. In particular, in the present embodiment, a column of an element type to which an element initially selected by the user belongs is displayed at a leftmost position, and element type columns including objects corresponding to elements topologically related to the initially selected element are sequentially added to the right. Therefore, a direction of movement of the light of sight and a direction of an order of addition (order of analysis) of element type columns are the same. This is a feature which further contributes toward improving visibility.

In addition, according to the present embodiment, on the failure investigation screen, elements (element objects) displayed in element type columns other than a lead element type column are narrowed down to elements topologically related to an element of interest (and further narrowed down to elements in which a same event as an event occurring in the element of interest is occurring). Accordingly, a height of the element type columns can be suppressed. Since the element type columns are arranged in the horizontal direction, suppressing the height of the element type columns contributes toward securing breadth of a work space to be arranged below (or above) a column space.

Furthermore, the present embodiment can be used in combination with RCA. Specifically, for example, it may be difficult to identify a root cause of an event (for example, a root cause of a failure) by RCA on its own. One reason for this is that RCA establishes, to the greatest extent feasible, built-in rules related to the identification of events which may possibly occur. On the other hand, in the present embodiment, the user can customize templates (display rules). In other words, the user can reflect his or her heuristics (knowledge) in a template. Therefore, it is expected that, for example, a burden of identifying a root cause of a failure can be reduced by RCA, and the burden can be further reduced by applying the user's heuristics (applying a template).

Moreover, while templates (built-in display rules) commonly prepared for a plurality of users regardless of a specific configuration of the information system 100 that is a monitoring target may conceivably be used, when performing a failure investigation, individual and specific situations in the information system 100 are preferably taken into consideration. A template in accordance with a display result in response to an actual user operation is a template which takes individual and specific actual situations in the information system. 100 into consideration and, further, which optimally uses user's heuristics. By using the template, it is expected that display that is more beneficial than when using built-in display rules can be performed with respect to the actual information system 100.

Next, specific examples of the user operations in the description given with reference to FIGS. 3 to 12 will be presented.

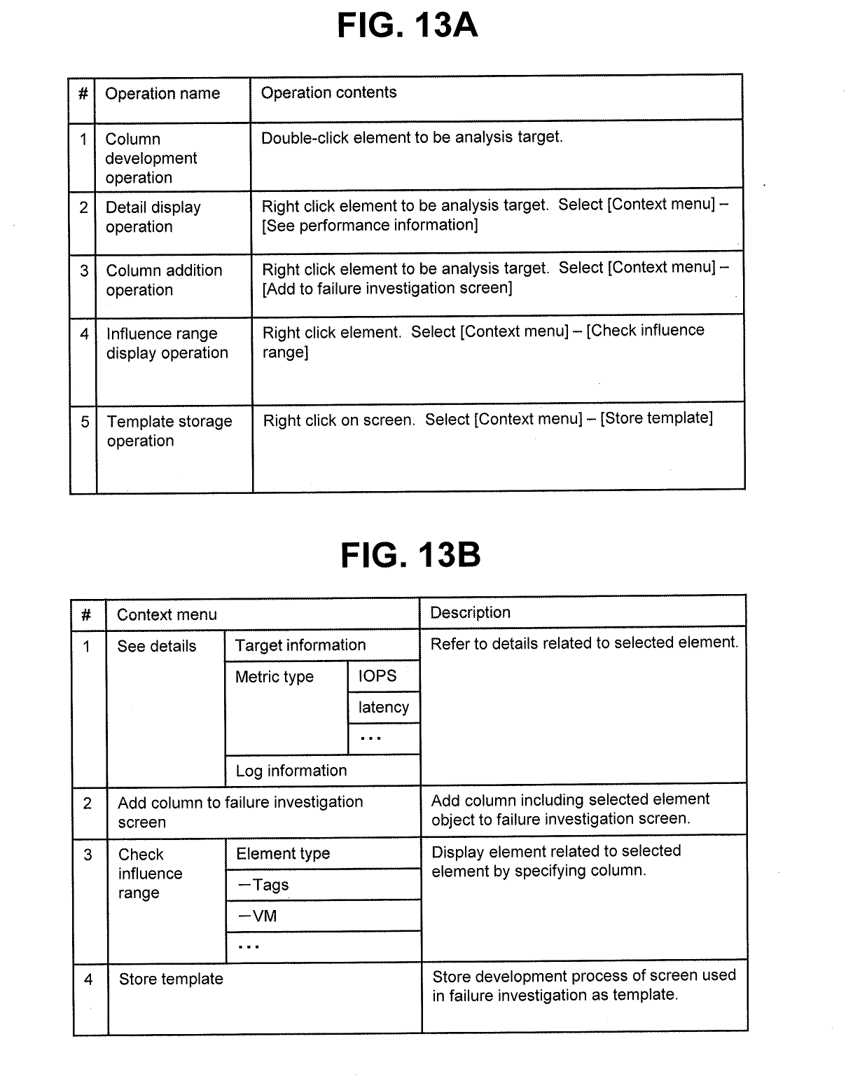

FIG. 13A shows an example of a relationship between user operations and operation contents. FIG. 13B shows an example of a relationship between user operations and context menus.

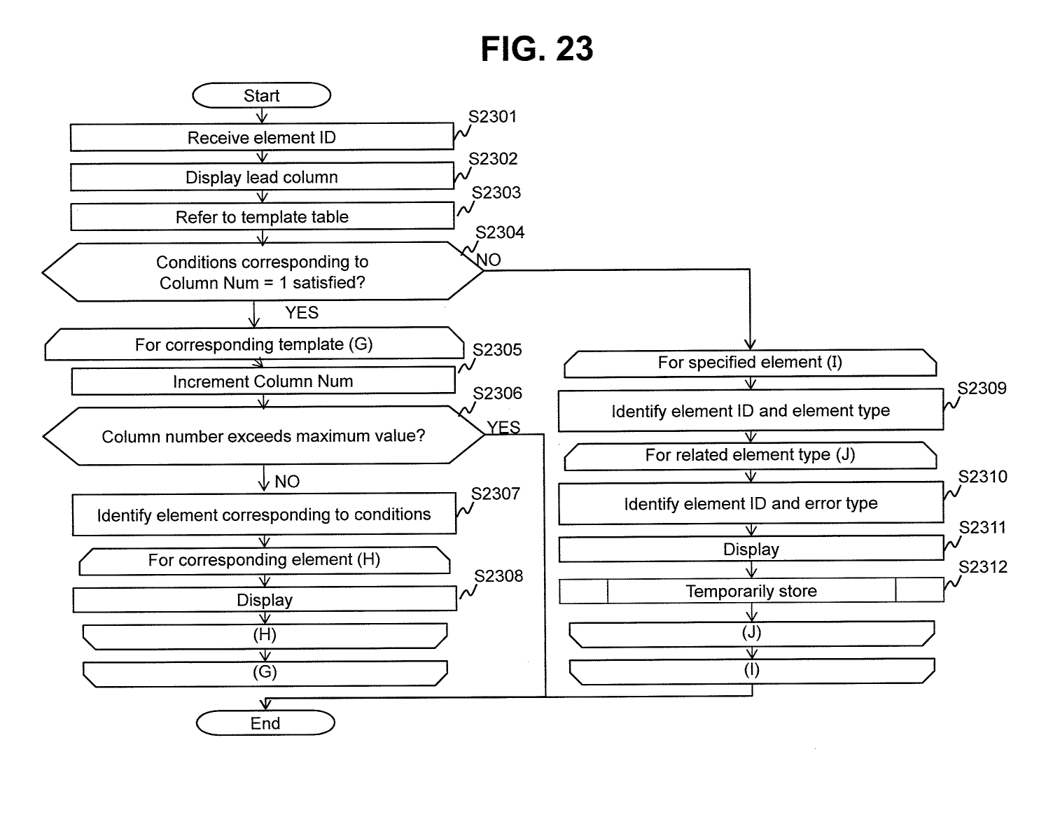

A column development operation involves, for example, double clicking an object of an element to be set as a target on the overall configuration screen. When the column development operation is performed, for example, the display changes as shown from FIGS. 3 to 4 or from FIGS. 11 to 12. When the column development operation is performed, the management server program 541 executes processes shown in FIGS. 23 to 25.

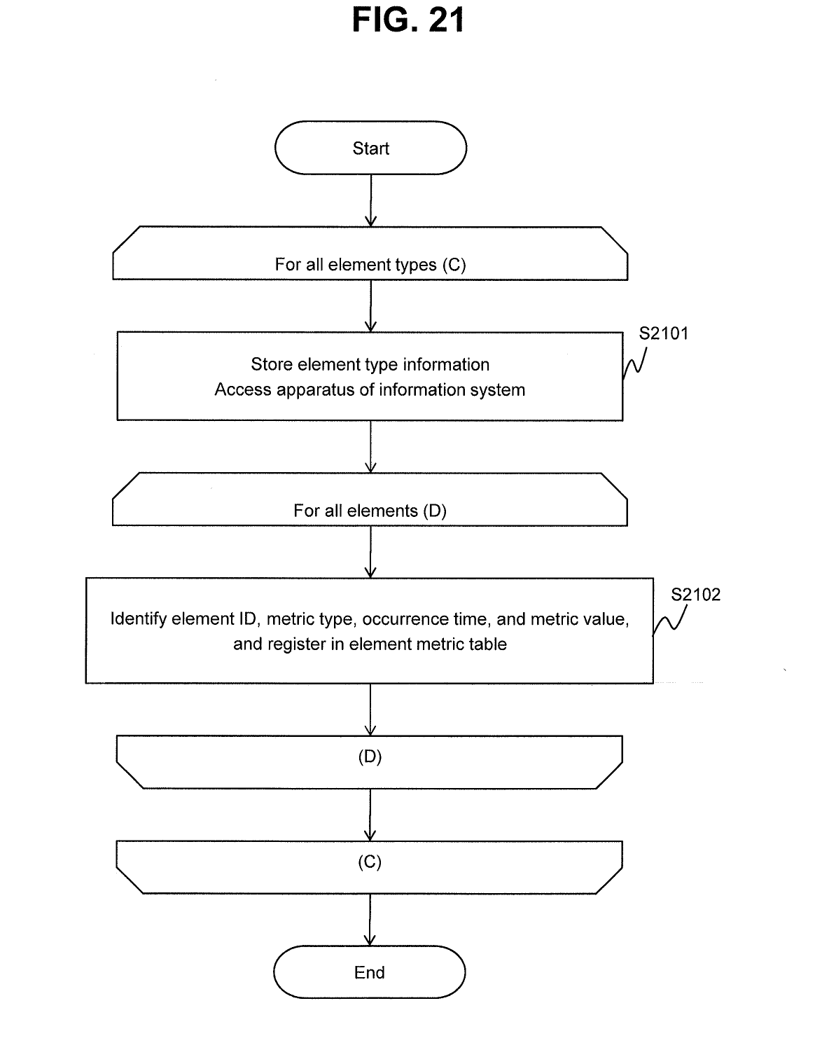

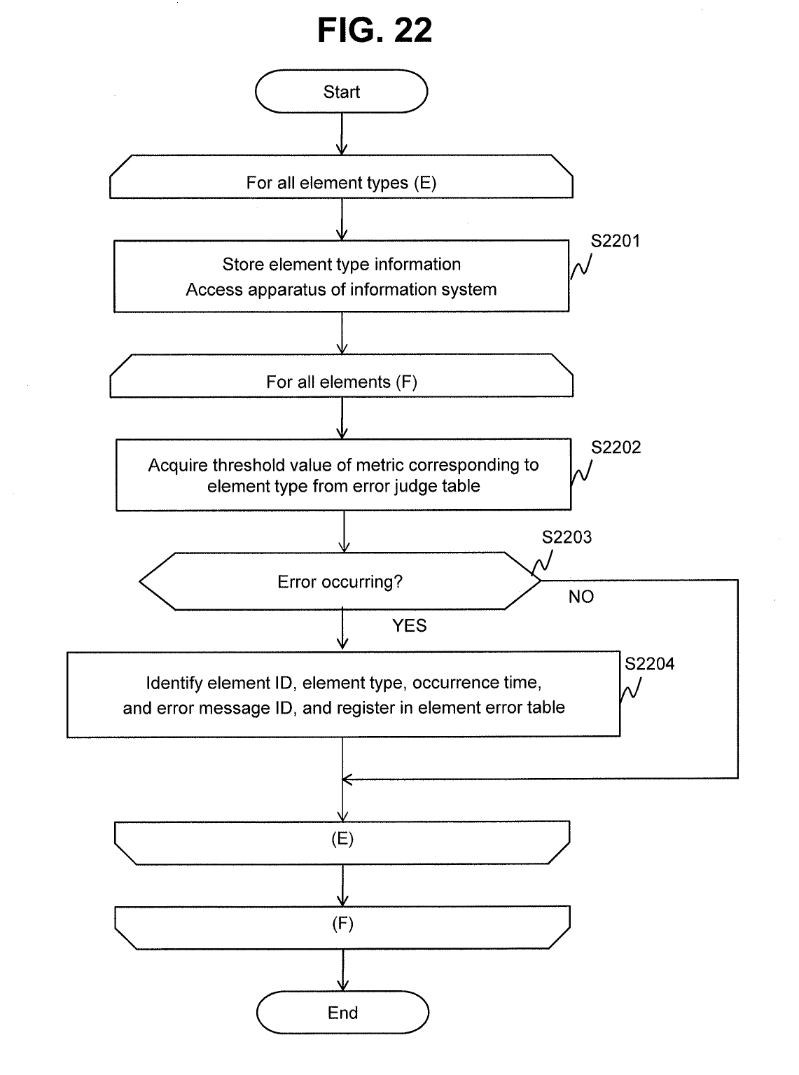

A detail display operation is an operation involving, for example, right-clicking an object of an element to be set as a target on the failure investigation screen to cause a context menu shown in FIG. 13B to be displayed, and selecting “See details” in the context menu. When the detail display operation is performed, details are displayed in the work space 420 of the failure investigation screen as shown in, for example, FIGS. 4, 7, 9, and 12. When the detail display operation is performed, the management server program 541 executes processes shown in FIGS. 21 and 22. Types of information to be displayed as details may be specifiable by, for example, a method such as receiving a selection of a metric type from the user as shown in FIG. 13B.

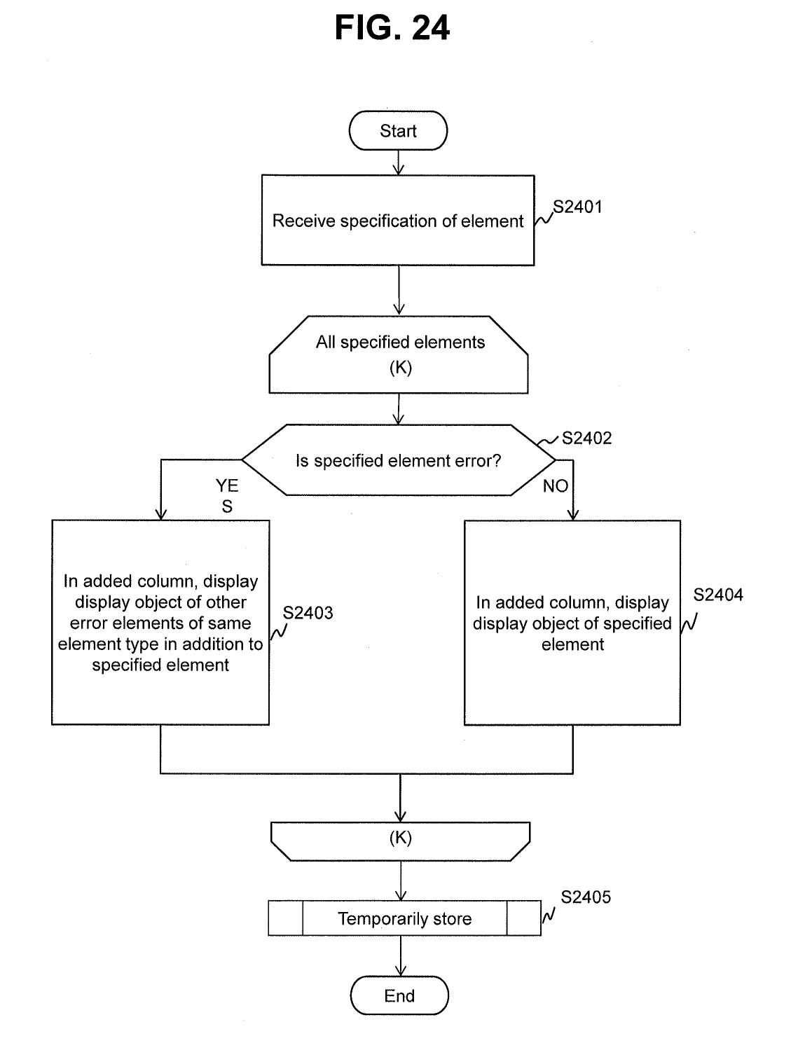

A column addition operation is an operation involving, for example, right-clicking an object of an element to be set as a target on the overall configuration screen (or another screen) to cause the context menu shown in FIG. 13B to be displayed, and selecting “Add column to failure investigation screen” in the context menu. When an operation for column addition is performed, for example, the display changes as shown from FIGS. 6 to 7 or from FIGS. 8 to 9. When the column addition operation is performed, the management server program 541 executes processes shown in FIG. 24.

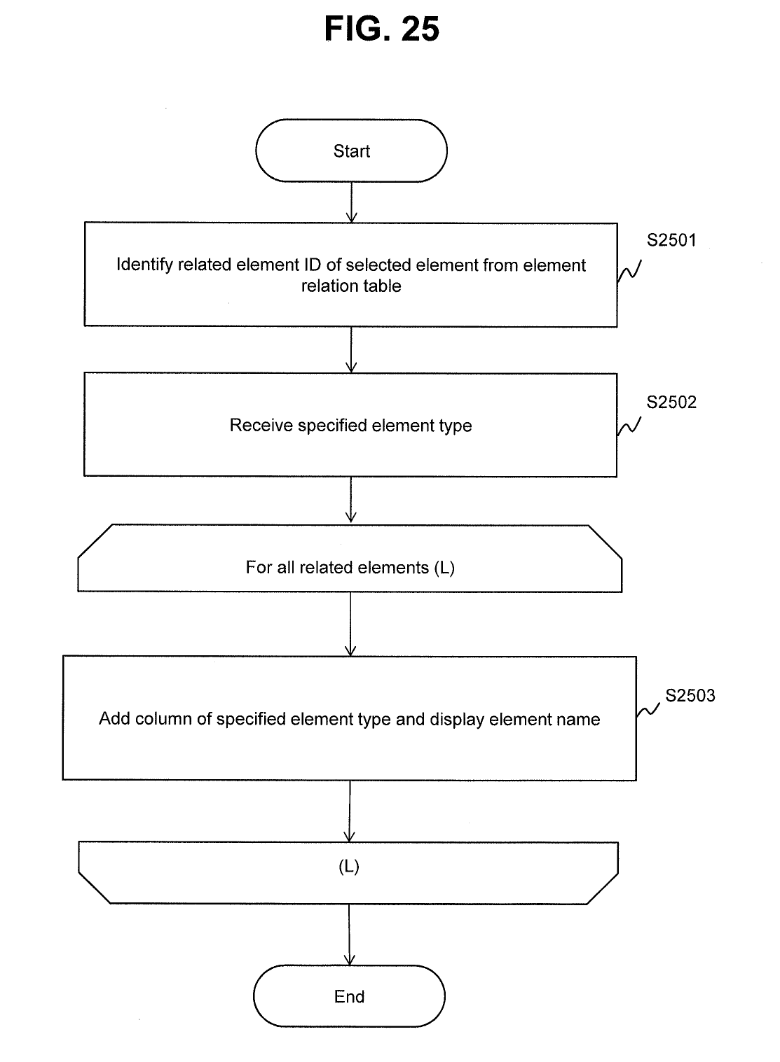

An influence range display operation is an operation involving, for example, right-clicking an object of an element of which an influence range is to be identified on the failure investigation screen to cause the context menu shown in FIG. 13B to be displayed, and selecting “Check influence range” (and element type desired by user)” in the context menu. When an operation for identifying an influence range is performed, a screen is displayed as shown in, for example, FIG. 10. When an operation for identifying an influence range is performed, the management server program 541 executes processes shown in FIG. 25. An element type corresponding to a column added in response to an influence range display operation may be the same as an element type corresponding to a lead column or may be an element type selected by the user.

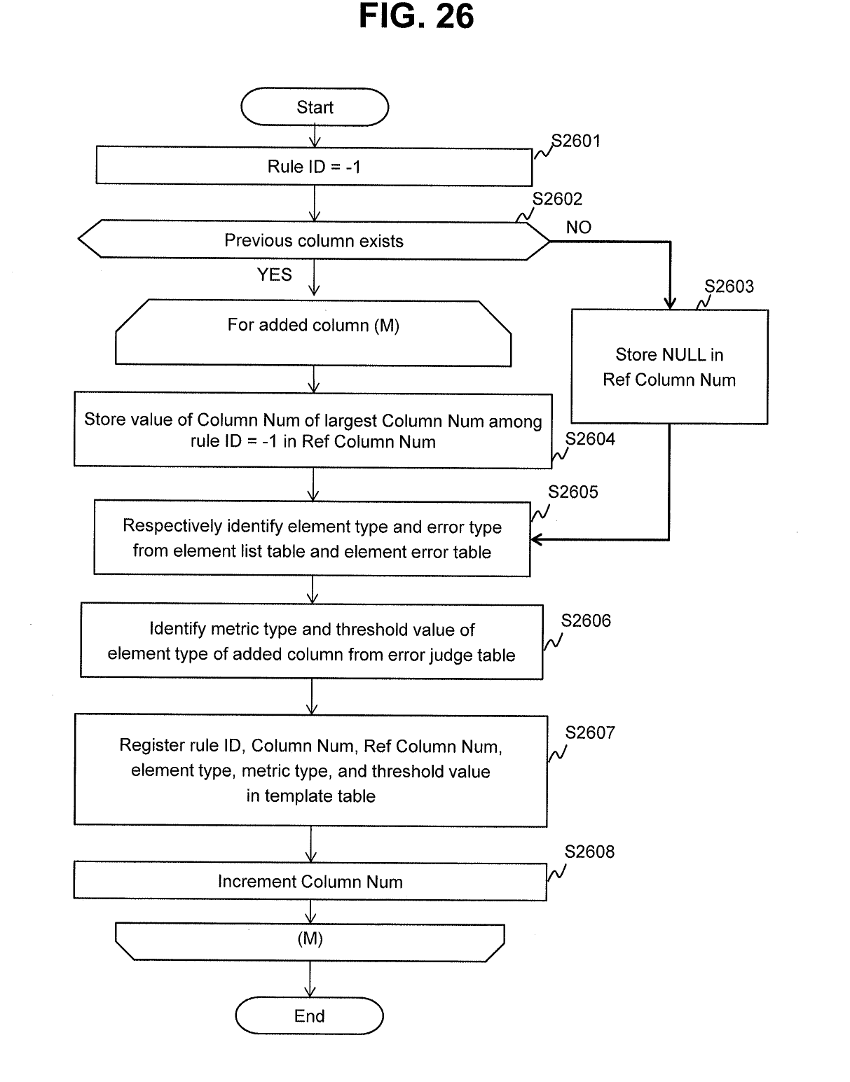

A template storage operation is an operation involving, for example, right-clicking on the failure investigation screen to cause the context menu shown in FIG. 13B to be displayed, and selecting “Store template” in the context menu. When an operation for storing a template is performed, the management server program 541 executes processes shown in FIG. 26.

Hereinafter, examples of processes performed by the management server program 541 and information referred to in the processes will be described.

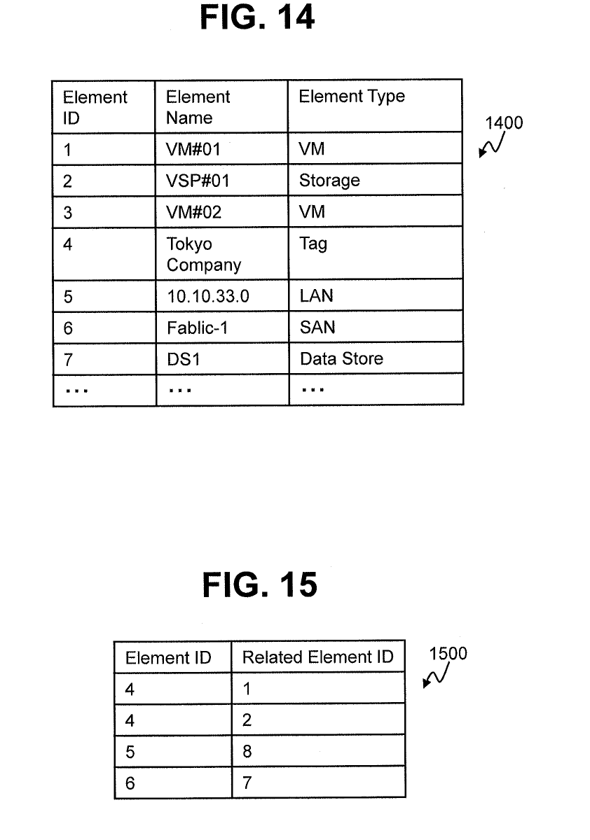

The management server program 541 is capable of collecting configuration information from all elements (for example, all nodes) in the information system 100 or from one or more prescribed elements in the information system 100 and constructing the tables shown in, for example, FIGS. 14 and 15 based on the collected configuration information. The tables shown in FIGS. 14 and 15 are, respectively, tables included in the information 543. In other words, information represented by the tables shown in FIGS. 14 and 15 is one the pieces of configuration information represented by the information 543. Based on the constructed table, the management server program 541 can detect a plurality of elements.

FIG. 14 shows an example of an element list table.

An element list table 1400 is an example of information included in the configuration information 543 and is a list of all elements in the information system 100. Specifically, for example, the table 1400 includes, for each element, an “Element ID” that is identification information assigned to the element, an “Element Name” that is a name of the element, and an “Element Type” that is a name of a type of the element.

FIG. 15 shows an example of an element relation table.

An element relation table 1500 is an example of information included in the configuration information 543 and represents a relationship between elements. Specifically, for example, the table 1500 includes, for each element, an “Element ID” and a “Related Element ID” that is an ID of an element related to the element.

The tables shown in FIGS. 14 and 15 represent a topological configuration or a relationship between element types as shown in FIG. 2. When an identifier (for example, a common name +an identification number) such as “VM #01” and “VSP #02” is used, each identifier represents an element. On the other hand, when a common name such as “VM” and “VSP” is used instead of an identifier, each common name represents an element type.

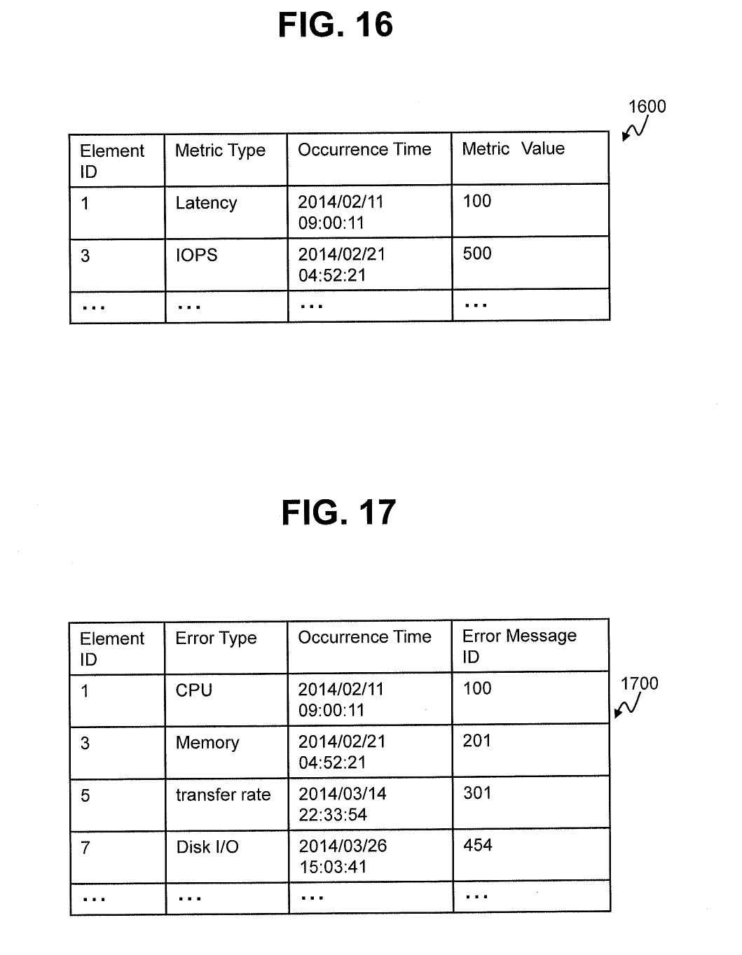

The management server program 541 receives a metric from all elements (for example, all nodes) in the information system 100 and registers the received metric in, for example, a table shown in FIG. 16. The table shown in FIG. 16 is a table included in the management information 542. Based on the constructed table, the management server program 541 can learn when and in which element a metric had been created.

FIG. 16 shows an example of an element metric table.

An element metric table 1600 is an example of information included in the monitoring result information 544 and represents a monitoring result of an element. The element metric table 1600 includes, for each element, an “Element ID” that is identification information of the element, a “Metric Type” that is a metric type with respect to the element, an “Occurrence Time” that is a time point at which a metric value had been acquired, and a “Metric Value” that represents the metric value.

The management server program 541 receives measurement information (a monitoring result) from all elements (for example, all nodes) in the information system 100 and updates the element metric table 1600 based on the received measurement information. In addition, when an error is detected in the measurement information, the management server program 541 updates an element error table.

FIG. 17 shows an example of the element error table.

An element error table 1700 is an example of information included in the monitoring result information 544 and represents information related to a detected error. The element error table 1700 includes, for each error, an “Element ID (Element Error Table)” that is identification information of an element in which the error had occurred, an “Error Type” that is a type of the error having occurred in the element, an “Occurrence Time” that is a time point at which the error had occurred, and an “Error Message ID” that is identification information of an error message.

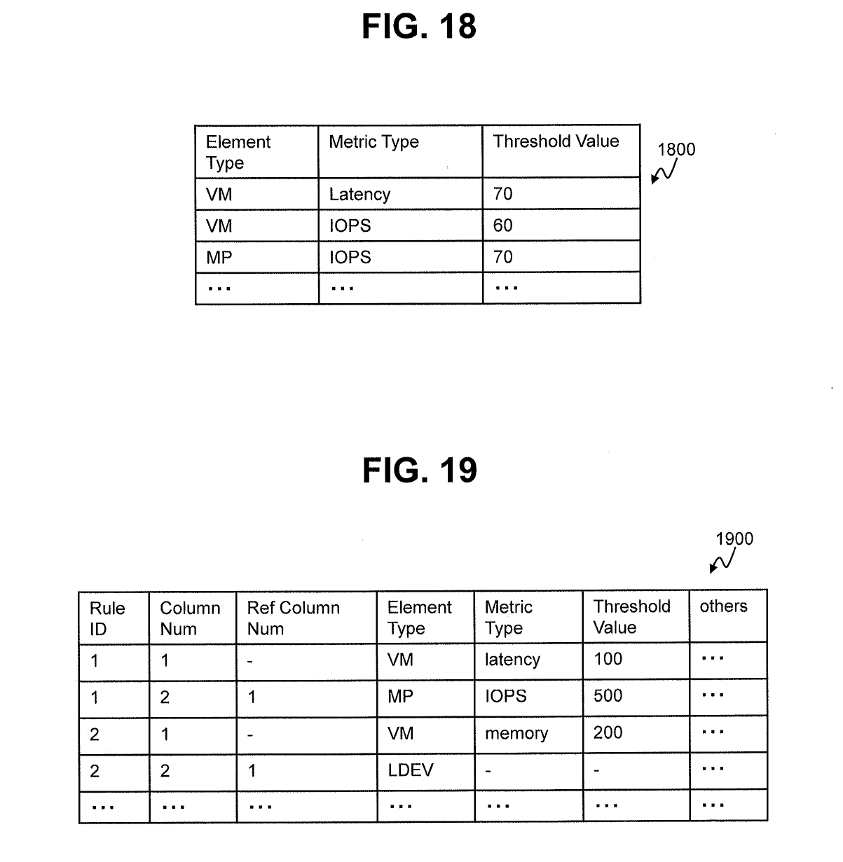

FIG. 18 shows an example of an error judge table.

An error judge table 1800 is an example of information included in the management information 542 and is a table used to judge an occurrence of an error. The error judge table 1800 includes, for each element type, an “Element Type” that is a name of a type of an element, a “Metric Type” that is a type of metric which occurs in the element, and a “Threshold Value” that is a threshold value used as a reference when judging that an error has occurred.

While the element error table 1700 and the error judge table 1800 are prepared in relation to a failure, an element warning table and a warning judge table may also be prepared in a similar manner.

FIG. 19 shows an example of a template table.

A template table 1900 is an example of information included in the management information 542 and represents information related to one or more templates. The template table 1900 includes one or more entries for each template. Each entry corresponds to an element type column displayed in the column space 410 in the failure investigation screen. An entry includes: a “Rule ID” that is identification information of the template; a “Column Num (column number)” that is a number of a column corresponding to the entry; a “Ref Column Num (reference destination column number)” that is a number of a reference destination column (a column adjacent to the left) ; an “Element Type” that is a type of an element corresponding to the column; a “Metric Type” that is a type of metric determined as an error in an element corresponding to the column; a “Threshold Value” that is a threshold value used when the element had been determined to be an error; and “Others” that include information such as a template name assigned to the template table and a template creation date. The template name may be a name input by the user in a template storage process that is performed in response to a template storage operation (or a name determined by the management server program based on contents of the temporary template table), and the template creation date may be an execution date of the template storage process or a final update date of the temporary template table 1950. The corresponding template list 412 shown in FIG. 12 may be generated and displayed based on “Others” of the template table 1900.

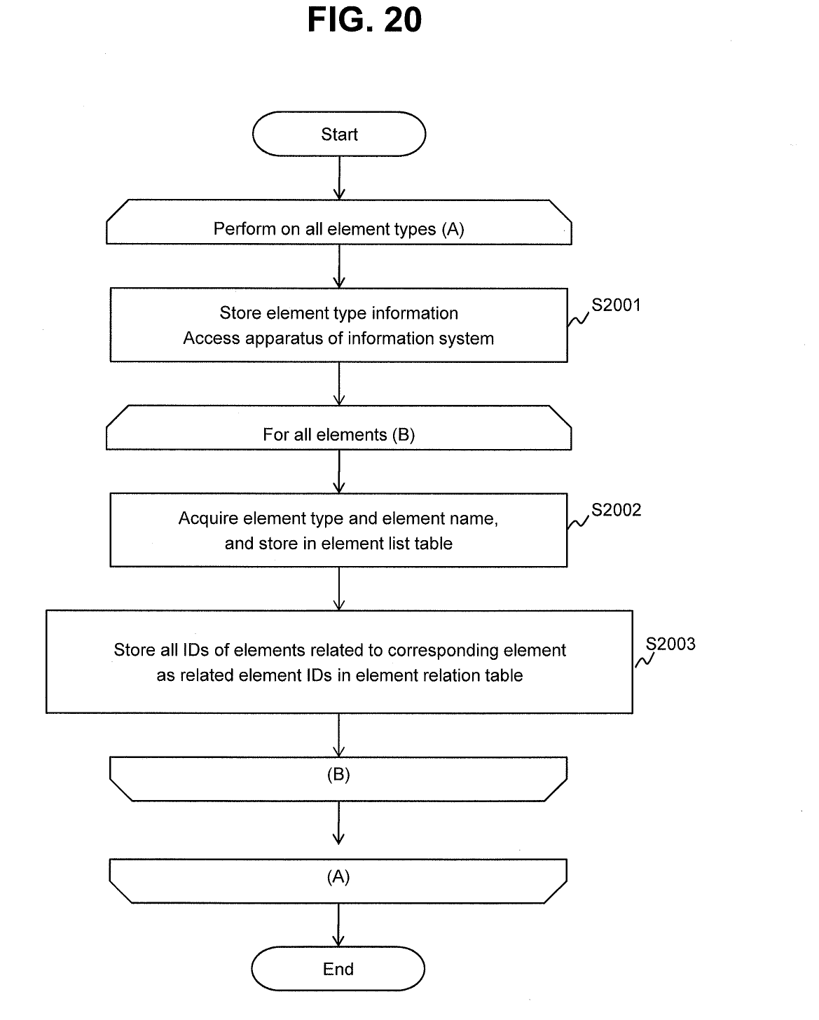

FIG. 20 shows an example of a flow of a configuration information acquisition process.

The configuration information acquisition process is a process for identifying a configuration of the information system 100 and may be executed repetitively (for example, periodically).

The management server program 541 executes S2001 to S2003 on element types of all elements of the information system 100 (loop A). Hereinafter, one element type (referred to as a “target element type” in the description of FIG. 20) will be taken as an example.

The management server program 541 accesses an apparatus (element) in the information system 100 storing information on elements of the target element type (S2001), and executes S2002 and S2003 on all elements of the target element type stored in the information system (loop B). One element (referred to as a “target element” in the description of FIG. 20) will now be taken as an example.

The management server program 541 acquires an element type and an element name of the target element from the accessed management system, and stores the acquired element type and element name in the element list table 1400 (S2002). Next, the management server program 541 registers all IDs of elements related to the target element as related element IDs in the element relation table 1500 (S2003).

FIG. 21 shows an example of a flow of a metric acquisition process.

The metric acquisition process is a process as an example of monitoring of the information system 100 and may be executed repetitively (for example, periodically).

The management server program 541 executes S2101 and S2102 on element types of all elements of the information system 100 (loop C). Hereinafter, one element type (referred to as a “target element type” in the description of FIG. 21) will be taken as an example.

The management server program 541 accesses an apparatus (element) in the information system 100 storing information on elements of the target element type (S2101), and executes S2102 on all elements stored in the apparatus (loop D). One element (referred to as a “target element” in the description of FIG. 21) will now be taken as an example.

The management server program 541 acquires an element ID, a metric type, an occurrence time, and a metric value of the target element from the accessed apparatus, and stores the acquired information in the element metric table 1600 (S2102).

FIG. 22 shows an example of a flow of an error information acquisition process.

The error information acquisition process is a process as an example of monitoring of the information system 100 and may be executed repetitively (for example, periodically).

The management server program 541 executes S2201 to S2204 on element types of all elements of the information system 100 (loop E). Hereinafter, one element type (referred to as a “target element type” in the description of FIG. 22) will be taken as an example.

The management server program 541 accesses an apparatus (element) in the information system storing information on elements of the target element type (S2201), and executes S2202 to S2204 on all elements stored in the apparatus (loop F). One element (referred to as a “target element” in the description of FIG. 22) will now be taken as an example.

The management server program 541 acquires a threshold value of a metric corresponding to the target element type from the error judge table 1800 (S2202). Next, the management server program 541 acquires a metric value of the target element from the accessed management system, and compares the metric value with the acquired threshold value of the metric to judge whether or not an error has occurred (S2203). As result, when an error has occurred (S2203: YES), the management server program 541 acquires an element ID, an element type, an occurrence time, and an error message ID from the accessed apparatus, and stores the acquired information in the element error table 1700 (S2204). On the other hand, when an error has not occurred (S2203: NO), the management server program 541 ends the process on the target element.

FIG. 23 shows an example of a flow of a column development process.

The column development process is a process performed in response to a column development operation.

The management server program 541 acquires an element ID specified in the column development operation (referred to as a specified element ID in the description of FIG. 23) (S2301). Next, the management server program 541 displays the failure investigation screen and displays an element object of an element of the received element ID in a first column (a leftmost column) on the failure investigation screen (S2302). Subsequently, the management server program 541 acquires all templates managed by the template table 1900 (S2303). In this case, one template is a set of entries (rows) in which a same rule ID is stored.

Next, the management server program 541 determines whether or not all elements corresponding to the specified element ID satisfy conditions (an element type, a metric type, and a threshold value) of an entry with 1 as a column number in any one of the acquired templates (S2304).

As a result, since a case where all elements corresponding to the specified element ID satisfy conditions of an entry with 1 as a column number (S2304: YES) means that there is an applicable template (corresponding template), the management server program 541 performs S2305 to S2308 on an entry corresponding to all columns of a template corresponding to a specified rule ID (loop G). In this case, the specified rule ID refers to a rule ID of a template to be set as a processing target among a plurality of templates satisfying the conditions of S2304. The specified rule ID may be, for example, a smallest rule ID among the plurality of templates satisfying the conditions of S2304. Alternatively, the specified rule ID may be a rule ID specified by the user (for example, a rule ID of a template specified in the template list 412 on the failure investigation screen shown in FIG. 12).

The management server program 541 increments (+1) a variable “column number” (S2305). Moreover, a variable “reference column number” is assumed to be the column number prior to the increment.

Next, the management server program 541 determines whether or not the variable “column number” has exceeded a maximum value (S2306).

As a result, when the variable “column number” has exceeded the maximum value (S2306: YES), the management server program 541 exits the loop G and ends the process. On the other hand, when the variable “column number” has not exceeded the maximum value (S2306: NO), the management server program 541 identifies an entry corresponding to the variable “column number” and the variable “reference column number” in the template of the specified rule ID, and identifies an element which corresponds to an element type of the entry and which satisfies conditions (a metric type and a threshold value) of the entry (S2307). Moreover, when a metric type and a threshold value are not configured to entries of the template, an element corresponding to an element type of the entry is identified.

Next, the management server program 541 executes S2308 on each of the specified elements (loop H). One element will now be taken as an example.

The management server program 541 displays an element object of the target element in an element type column corresponding to the variable “column number” on the failure investigation screen (S2308). Moreover, when an element type column corresponding to the column number is not yet displayed on the failure investigation screen, an element type column corresponding to the column number is displayed.

On the other hand, since a case where all elements corresponding to the specified element ID do not satisfy conditions of an entry with 1 as a column number (S2304: NO) means that there is no applicable template, the management server program 541 performs S2309 to S2312 on each element (referred to as a “specified element” in the description of FIG. 23) corresponding to all specified element IDs (loop I). Hereinafter, one specified element (referred to as a “target specified element” in the description of FIG. 23) will now be taken as an example.

The management server program 541 acquires an element ID and an element type of an element related to the target specified element from the element relation table 1500 (S2309). Next, the management server program 541 executes S2310 to S2312 on each of the element types to which the related elements belong (loop J). Hereinafter, one related element (referred to as a “target related element” in the description of FIG. 23) will now be taken as an example.

The management server program 541 refers to the element error table 1700, and when an error is occurring in the target related element, acquires an element ID and an error type of the target related element (S2310), displays the target related element in a second column on the failure investigation screen (S2311), and executes a temporary template storage process (FIG. 26) on the target related element (S2312).

FIG. 24 shows an example of a flow of a column addition process.

The column addition process is a process performed in response to a column addition operation.

The management server program 541 receives an ID of an element specified in the column addition operation (referred to as a “specified element” in the description of FIG. 24) (S2401). Next, the management server program 541 executes S2402 to S2404 on each of the specified elements (loop K). Hereinafter, one specified element will now be taken as an example.

The management server program 541 determines whether or not an error is occurring in the specified element (S2402).

As a result, when an error is occurring in the specified element (S2402: YES), an element type column of an element type of the specified element is added to the failure investigation screen, and an element object of an element which is of a same element type as the specified element and in which an error is occurring is displayed together with an element object of the specified element in the added column (S2403).

On the other hand, when an error is not occurring in the specified element (S2402: NO), the management server program 541 adds an element type column of an element type of the specified element to the failure investigation screen, and displays an element object of the specified element in the added column (S2404).

After loop K, the management server program 541 executes a temporary template storage process (FIG. 26) on a target column in accordance with the column addition process (S2405).

FIG. 25 shows an example of a flow of an influence range display process.

The influence range display process is a process performed in response to an influence range display operation.

The management server program 541 acquires a related element ID corresponding to an element specified in the influence range display operation (referred to as a “specified element” in the description of FIG. 25) from the element relation table 1500 (S2501).

The management server program 541 receives an element type of an element of the acquired related element ID (referred to as a “specified element type” in the description of FIG. 25) (S2502).

Next, the management server program 541 executes S2503 on all related elements corresponding to the related element ID (loop L). Hereinafter, one related element (referred to as a “target related element” in the description of FIG. 25) will now be taken as an example.

The management server program 541 adds an element object of a related element to a column of the specified element type (S2503). Moreover, when the column of the specified element type has not been newly added, the management server program 541 adds the column of the specified element type to the failure investigation screen.

FIG. 26 shows an example of a flow of a temporary template storage process.

The temporary template storage process is a process corresponding to S2312 in FIGS. 23 and S2405 in FIG. 24.

The management server program 541 sets a variable “rule ID” to −1 (S2601). Next, the management server program 541 determines whether or not a previous column (a column preceding a last-added column) exists (S2602). When a previous column does not exist (S2602: NO), the management server program 541 stores NULL in the variable “reference column number” (S2603). On the other hand, when a previous column exists (S2602: YES), the management server program 541 executes S2604 to S2608 on the added column (loop M). Hereinafter, one element (referred to as a “target element” in the description of FIG. 26) in the added column will now be taken as an example.

The management server program 541 stores a value of a column number in an entry which has a largest column number and of which rule ID=−1 in the template table 1900 in the variable “reference column number”.

Next, the management server program 541 acquires an element type of the target element from the element list table 1400 and acquires an error type of the target element from the element error table 1700 (S2605).

Subsequently, the management server program 541 acquires a metric type and a threshold value corresponding to the element type of the target element from the error judge table 1800 (S2606).

Next, the management server program 541 adds an entry including the value of the variable “rule ID”, the value of the variable “column number”, the value of the variable “reference column number”, the acquired element type, metric type, and threshold value to the temporary template table 1950 (S2607), and increments the variable “column number” (S2608).

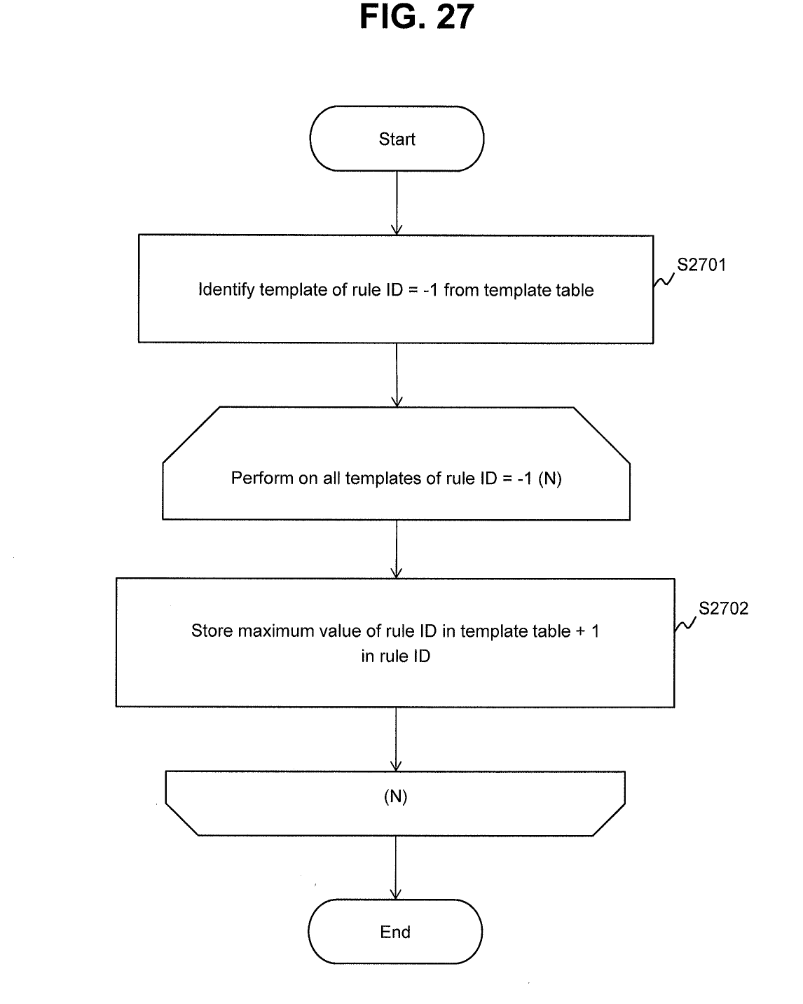

FIG. 27 shows an example of a flow of a template storage process.

The template storage process is a process performed in response to a template storage operation.

The management server program 541 acquires a template of which rule ID=−1 from the temporary template table 1950.

Next, the management server program 541 acquires a template (entries) of which rule ID=−1 from the temporary template table 1950 (S2701).

Subsequently, the management server program 541 executes S2702 on each entry of the template of which rule ID=−1 (loop N). Hereinafter, one entry will be taken as an example.

The management server program 541 stores a value obtained by adding 1 to a largest value prior to executing loop N among rule IDs in the template table 1900 in the rule ID of the entry, and stores entries including the rule ID in the template table 1900 (S2702). In doing so, the management server program 541 also stores a template name and a template creation date in the corresponding entries in the template table 1900.

While an embodiment has been described above, it is to be understood that the described embodiment merely represents an example for illustrating the present invention and that the scope of the present invention is not limited to the embodiment. The present invention can also be implemented in various other modes.

For example, instead of a screen with a multi-column format, the overall configuration screen may be a general topology view screen in which a relationship between elements is expressed by a connection.

In addition, for example, conditions of an element (object) displayed in second and subsequent element type columns on the failure investigation screen may include that the element is related to L-number of elements (objects) among K-number of elements (objects) in the lead element type column, where K is an integer equal to or larger than 1. L is equal to or smaller than K and may be a value determined based on a prescribed proportion h (0<h≦1) relative to K.

Furthermore, tables need not be divided into, for example, the temporary template table 1950 and the template table 1900, and the temporary template table 1950 may be omitted. In this case, in the template table 1900, a rule ID of an entry corresponding to a temporary template may be given a value such as “−1” which indicates a correspondence with a temporary template.

In addition, on the failure investigation screen, a name of a user operation (for example, a column development operation, a column addition operation, or an influence range display operation) having triggered the display of each of the second element type columns may be displayed in association with the columns.

### REFERENCE SIGNS LIST

100 Information system

555 Management client

557 Management server

1. A management system for managing an information system including a plurality of elements belonging to a plurality of types, the management system comprising:
an interface device coupled to the information system;
a storage unit; and
a processor configured to detect the plurality of elements by collecting configuration information from the information system, store the configuration information in the storage unit, and monitor the plurality of detected elements, the processor being configured to:
(A) determine whether or not a display rule is stored in the storage unit, the display rule considering a selected type that is a type to which one or more elements selected based on a monitoring result belong, to be a first type; and
(B) when a determination result of (A) is positive, display two or more columns which are arranged in an arrangement order in accordance with the display rule,
the display rule being a customized rule and including the first type, one or more second types, and an arrangement order of display of two or more columns respectively corresponding to the first type and the one or more second types,
a first column which is a lead column among the two or more columns displayed in (B), and a column corresponding to the selected type, displaying one or more objects respectively corresponding to the one or more selected elements, and
each of one or more second columns which are one or more columns other than the first column among the two or more columns displayed in (B), displaying an object corresponding to an element which belongs to a type corresponding to the second column and which is topologically related to at least one of the one or more selected elements.

2. The management system according to claim 1, wherein an M-th second column among the two or more columns displayed in (B) displays objects corresponding to elements in which a same event as an event occurring in at least one of the one or more selected elements is occurring (where M is an integer equal to or larger than 2).

3. The management system according to claim 2, wherein an N-th second column among the two or more columns displayed in (B) displays objects respectively corresponding to all elements topologically related to an element corresponding to an object selected from objects displayed in the M-th second column (where N>M).

4. The management system according to claim 3, wherein a type corresponding to the M-th second column is a same type as a type corresponding to the first column.

5. The management system according to claim 1, wherein
in (B), the two or more columns are displayed in a column space on a screen including the column space and a work space,
the work space is positioned above or below the column space on the screen, and
the processor is configured to, when receiving specification of any of objects displayed on the screen and specification of detailed display, display in the work space information representing a monitoring result with respect to an element corresponding to the specified object or information related to an element which corresponds to this element and which belongs to a type that differs from a type to which this element belongs.

6. The management system according to claim 1, wherein
the two or more columns displayed in (B) are arranged in an arrangement order in accordance with a display rule selected from display rules for which a determination result of (A) is positive,
in (B), the processor is configured to display a list of identification information of display rules for which a determination result of (A) is positive,
in the list, identification information of the selected display rule is highlighted, and
the processor is configured to, when receiving selection of another display rule in the list, update display of at least columns other than a lead column in the two or more columns in accordance with the other selected display rule.

7. The management system according to claim 1, wherein the display rule is a rule determined in accordance with a previous user operation related to column display.

8. The management system according to claim 7, wherein
the processor is configured to, when a determination result of (A) is negative,
(C) display a column corresponding to the selected type as a lead column,
(D) display, every time an element topologically related to at least one of the one or more selected elements is selected in accordance with a user operation, a column including an object corresponding to the selected element or an object corresponding to an element topologically related to the selected element so as to be arranged side by side with an immediately previous column, and
(E) store, when receiving a storage instruction of a display rule, a display rule regulating an arrangement order of displayed columns in the storage unit,
in the display rule stored in (E), a first type being the selected type corresponding to the lead column among the displayed columns, and a second type being a type corresponding to a column other than the lead column among the displayed columns.

9. The management system according to claim 8, wherein
in each of (C) and (D), columns are displayed in a column space on a screen including the column space and a work space,
the work space is positioned above or below the column space on the screen, and
in each of (C) and (D), the processor is configured to, when receiving specification of any of objects displayed on the screen and specification of detailed display, display in the work space information representing a monitoring result with respect to an element corresponding to the specified object or information related to an element which corresponds to this element and which belongs to a type that differs from a type to which this element belongs.

10. The management system according to claim 8, wherein
in (C), the processor is configured to, when there is at least one element which is topologically related to at least one of the one or more selected elements and in which a same event as an event occurring in at least one of the one or more selected elements is occurring, display one or more columns respectively corresponding to one or more types to which the at least one element belongs, and
in each of the one or more displayed columns, objects are displayed that correspond to all elements which belong to a type corresponding to the column, which are topologically related to at least one of the one or more selected elements, and in which a same event as an event occurring in at least one of the one or more selected elements is occurring.

11. The management system according to claim 8, wherein
when an element selected in (D) is an element in which an event is occurring, an object corresponding to another element which belongs to a same type and in which a same event is occurring is also displayed in a same column, and
when an element selected in (D) is an element in which an event is not occurring, only the selected element is displayed in a column.

12. The management system according to claim 1, wherein the display rule includes conditions under which an element is considered to be a display target with respect to a column which displays an object corresponding to an element in which an event is occurring among the two or more columns.

13. The management system according to claim 12, wherein
the event is a failure, and
the conditions are a metric type for determining that a failure has occurred in a selected event and a threshold value of a metric value belonging to the metric type.

14. The management system according to claim 1, wherein the two or more columns displayed in (B) are arranged left to right or right to left in accordance with the arrangement order.

15. A management program to be executed on at least one computer coupled to an information system including a plurality of elements of a plurality of types, the management program causing the at least one computer to:
detect the plurality of elements by collecting configuration information from the information system;
monitor the plurality of detected elements;
determine whether or not there exists a display rule which considers a selected type that is a type to which one or more elements selected based on a monitoring result belong, to be a first type; and
when a determination result thereof is positive, display two or more columns which are arranged in an arrangement order in accordance with the display rule,
the display rule being a customized rule and including the first type, one or more second types, and an arrangement order of display of two or more columns respectively corresponding to the first type and the one or more second types,
a first column which is a lead column among the two or more displayed columns, and a column corresponding to the selected type, displaying one or more objects respectively corresponding to the one or more selected elements, and
each of one or more second columns which are one or more columns other than the first column among the two or more displayed columns, displaying an object corresponding to an element which belongs to a type corresponding to the second column and which is topologically related to at least one of the one or more selected elements.
